(19) United States
(12) Patent Application Publication
(10) Pub. No.: US 2005/0280846 A1
(43) Pub. Date: Dec. 22, 2005

(54) Image processing apparatus, image processing method and image forming apparatus

(75) Inventor: Shuji Ichitani, Tokyo (JP)

Correspondence Address: FRISHAUF, HOLTZ, GOODMAN & CHICK, PC, 220 5TH AVE FL 16, NEW YORK, NY, 10001-7708, US

(73) Assignee: KONICA MINOLTA BUSINESS TECHNOLOGIES, INC., Tokyo (JP)

(21) Appl. No.: 11/015,077

(22) Filed: Dec. 16, 2004

(30) Foreign Application Priority Data
Jun. 8, 2004 (JP) JP2004-170382

(51) Int. Cl. H04N 1/56; H04N 1/60

(52) U.S. Cl. 358/1.9; 358/523; 358/504

(57) ABSTRACT

An image processing apparatus for creating a 3D color information conversion table for converting a color image signal of one signal processing system into a color image signal of the other signal processing system, based on color measurement signals obtained by measuring of a reference color original, and image reading signals obtained by reading the reference color originals, the image processing apparatus including: an interpolation processing unit for obtaining output values of the color measurement signals corresponding to RGB input values on four apexes enclosing a RGB input value of a computation target point; and an extrapolation processing unit for obtaining the output values of the color measurement signal corresponding to RGB input values of three apexes enclosing the RGB input value of the computation target point and to a RGB input value of the computation reference point.

### BACKGROUND OF THE INVENTION

The present invention relates to an image processing apparatus and an image processing method preferably applicable to a three-dimensional color conversion table for converting the image information of an RGB signal processing system into that of a YMCK-signal processing system, and to an image forming apparatus preferably applicable to a color printer, color copying machine, and multifunction device thereof for forming an color image based on the three dimensional color conversion table.

In recent years, there have been a growing number of cases where a tandem type color printer, color copying machine and their multifunction machine are utilized. These color image forming apparatuses are equipped with an exposure section, a developing apparatus and a photoconductor drum for each color of yellow (Y), magenta (M), cyan (C) and black (K), as well as an intermediate transfer belt and a fixing device.

For example, the exposure section for Y color allows an electrostatic latent image to be formed on the photoconductor drum, based on desired image information. The developing apparatus causes Y-color toner to be attached onto the electrostatic latent image formed on the photoconductor drum, whereby a color toner image is formed. The photoconductor drum allows the toner image to be transferred onto the intermediate transfer belt. The same procedure applies to the colors M, C and K. The color toner image transferred onto the intermediate transfer belt is fixed by a fixing device after having been transferred on to a sheet of paper.

The color image forming apparatus of this type often contains the three-dimensional color information conversion table (three-dimensional lookup table, hereinafter also referred to as “3D-LUT”) for converting the image information of the signal processing system for red (R), green (G) and blue (B) into that of the YMCK signal processing system. This is because the image forming apparatus uses a mechanism that operates based on the image information of the YMCK signal processing system.

The 3D-LUT is created by matrix processing and interpolation computation, from the readings (XYZ and Lab) of the N³ patch original where N patches are arranged so that the intensity of three RGB colors, for example, is increased, and the scanner signal (RGB). Thus, the RGB signal is converted into the XYZ output signal and Lab output signal.

A non-Patent Document, for example, refers to the 3D-LUT creation method, wherein the scanned RGB value and measured XYZ value are correlated according to a 3-row by 3-column matrix (hereinafter referred to as “primary matrix”) calculation formula, Eq. (1).

$$[ Eq . 1 ] \\ [ \begin{matrix}X \\ Y \\ Z\end{matrix} ] = [ \begin{matrix}a11 & a12 & a13 \\ a21 & a22 & a23 \\ a31 & a32 & a33\end{matrix} ] \times [ \begin{matrix}R \\ G \\ B\end{matrix} ] \qquad ( 1 )$$

The 3D-LUT is created by obtaining the matrix coefficients a11 through a13, a21 through a23, and a31 through a33.

Further, the scanned RGB value and measured XYZ value are correlated according to a 3-row by 9-column matrix (hereinafter referred to as “secondary matrix”) calculation formula, Eq. (2).

$$[ Eq . 2 ] \\ [ \begin{matrix}X \\ Y \\ Z\end{matrix} ] = [ \begin{matrix}a11 & a12 & a13 \\ a21 & a22 & a23 \\ a31 & a32 & a33\end{matrix} ⋯ \begin{matrix}a17 & a18 & a19 \\ a27 & a28 & a29 \\ a37 & a38 & a39\end{matrix} ] \times [ \begin{matrix}R \\ G \\ B \\ {R}^{2} \\ {G}^{2} \\ {B}^{2} \\ RG \\ GB \\ BR\end{matrix} ] \qquad ( 2 )$$

The 3D-LUT is created by obtaining the matrix coefficients a11 through a19, a21 through a29, and a31 through a39.

Further, the scanned RGB values and measured XYZ values are corrected according to a 3-row by 19-column matrix (hereinafter referred to as “tertiary matrix”) calculation formula, Eq. (3).

$$[ Eq . 3 ] \\ [ \begin{matrix}X \\ Y \\ Z\end{matrix} ] = [ \begin{matrix}a11 & a12 & a13 \\ a21 & a22 & a23 \\ a31 & a32 & a33\end{matrix} ⋯ \begin{matrix}a117 & a118 & a119 \\ a217 & a218 & a219 \\ a317 & a318 & a319\end{matrix} ] \times [ \begin{matrix}R \\ G \\ B \\ {R}^{2} \\ {G}^{2} \\ {B}^{2} \\ RG \\ GR \\ BR \\ {R}^{3} \\ {G}^{3} \\ {B}^{3} \\ {R}^{2} G \\ {R}^{2} B \\ {G}^{2} B \\ {G}^{2} R \\ {B}^{2} R \\ {B}^{2} G \\ RGB\end{matrix} ] \qquad ( 3 )$$

The 3D-LUT is created by obtaining the matrix coefficients a11 through a11 through a119, a21 through a219, and a31 through a319.

The type of these matrix calculations is characterized in that color difference is decreased as the order is increased from first to second, then to third and so on, but the connection between the 3D-LUT lattice points tends to deteriorate.

Of the methods for creating the 3D-LUT based on the matrix calculation technique, the interpolation computation procedure method, the color image reproduction apparatus and the method thereof are disclosed in Patent Documents. According to this color image reproduction apparatus, the scanned RGB values obtained by reading an original through scanning exposure, and the color measured XYZ values are associated with each other by vector computation, wherein the association is carried out by interpolation processing. Especially when extrapolation method is used, the relation of the distance is obtained from the scanned RGB values of four lattice points close to the RGB input value of the target point for computation, and the XYZ output value with respect to the RGB input value is obtained from the distance from the Lab value of the four lattice points. This procedure significantly improves the color difference as compared to the matrix calculation method, and allows the color of a document to be reproduced accurately, simply and quickly.

Extrapolation method is used when the computation target point (lattice point) of the RGB input value is not included the RGB plot range of the scanner signal according to the Patent Document. FIG. 22 is a G-R color gradation lattice diagram representing an example of the color gamut lattice in the extrapolation processing mode in a prior art example. The example of the color gamut lattice shown in FIG. 22 is a schematically enlarged view of the color gamut peripheral portion of the computation target point in a 3D color coordinate system, wherein the R-G color coordinate system (2D) is extracted from the 3D color coordinate system. In this example, the scanned RGB values and RGB input values are shown in two-dimensional terms.

The vertical line shown in FIG. 22 indicates the lattice (gradation) line of the G (green) color that provides the 3D-LUT lattice point, whereas the horizontal line represents the lattice (gradation) line of the R (red) color. The black dots are obtained by plotting the scanned RGB values in the color gamut peripheral portion. These black dots are connected with one another by a solid line. For other scanned RGB values plotted, the black dots are also connected by a solid line.

Examples 1 through 3 shown in FIG. 22 refer to the computation target point set on the lattice point of the R-G color coordinate system. The RGB input value of the computation target point is given by the RGB input value at the crossing point of the 3D-LUT lattice.

For example, when extrapolation is applied to the lattice point of an example 1 of computation target shown in FIG. 22, two nodes on the periphery of the color gamut and one node inside it are utilized. Accordingly, the direction of applying extrapolation to the lattice point of the computation target example 1 is included between two vectors, β11 and β12, as shown in FIG. 22. Similarly, the lattice point of the computation target example 2 is also extrapolated between two vectors, β21 and β22; and the lattice point of the computation target example 3 is also extrapolated between two vectors, β31 and β32. As will be apparent from the direction of the vector of the computation target examples 2 and 3, vectors β21 and β31, and vectors β22 and β32 cross each other. This means that the continuity of the Lab output value is lost when the computation target examples 1, 2 and 3, and the result of extrapolation are traced sequentially.

[Non-Patent Document 1] (SPIE Vol. 1448 Camera and Input Scanner Systems (1991) P. 164-174)

[Patent Document 1] Official Gazette of Japanese Patent Tokkaihei 6-30251 (page 5, FIGS. 9 and 10)

Incidentally, two nodes on the periphery of the color gamut of the computation target example 1 in the extrapolation processing mode and one node inside it are used in the method of creating the 3D-LUT using the prior art interpolation calculation processing technique. This involves the following problems:

i. The lattice point of the computation target example 1 is extrapolated between two vectors β11 and β12, as shown in FIG. 22. The lattice point of the computation target example 2 is also extrapolated between two vectors 121 and β22, and the lattice point of the computation target example 3 is also extrapolated between two vectors β31 and β32. Thus, the direction of the vectors in computation target examples 2 and 3 indicates that vectors β21 and β31, and vectors β22 and β32 cross each other. Such an intersection of the vector causes color conversion to deteriorate in smoothness.

ii. Incidentally, when the measured XYZ values obtained by the prior art extrapolation method is converted into the Lab value of the lightness/chromaticity 3D coordinate system (hereinafter referred to as “Lab color coordinate system”), the connection between the 3D-LUT lattice points will deteriorate. For example, when the color in the range wider than the N³ patch original has been scanned, or color adjustment has been made by operating the scanned RGB data obtained from the patch original being scanned normally, the RGB values cover a wider range than the N³ patch original, as a result of this adjustment. In this case, the poor connection will reduce the image quality.

iii. As described above, the prior art interpolation computation processing technique brings about a drastic improvement of the color difference as compared to the matrix calculation method, but the smoothness of 3D-LUT is much deteriorated by the extrapolation method. This has been the problem with the prior art.

### SUMMARY OF THE INVENTION

The present invention has been made to solve the aforementioned problem. The object of the present invention is to provide an image processing apparatus, image processing method and image forming apparatus wherein the color difference in the color image signal of the other signal processing system and smoothness in color conversion in the 3D color information conversion table can be made compatible with each other, when the color image signal of one signal processing system is to be converted into the color image signal of the other signal processing system. The aforementioned object can be achieved by the following configuration:

(1). An image processing apparatus for creating a 3D color information conversion table for converting a color image signal of one signal processing system into a color image signal of the other signal processing system, based on: color measurement signals obtained by color measuring of a reference color original where N-fold N² pieces of reference color images are arranged in such a way that respective intensities of red, green and blue (RGB) of the reference color images are increased in order; and image reading signals obtained by reading the reference color originals through light exposure scanning; the image processing apparatus being provided with: an interpolation processing unit for obtaining output values of the color measurement signals corresponding to RGB input values on four apexes enclosing a RGB input value of a computation target point, when the image reading signals are expanded on a color 3D coordinate system to express the RGB input value for creating the 3D color information conversion table; an extrapolation processing unit for extracting a computation reference point out of the image reading signals expressed on the color 3D coordinate system, fixing the computation reference point, connecting between the computation reference point and the computation target point, and thereby obtaining the output values of the color measurement signal corresponding to RGB input values of three apexes enclosing the RGB input value of the computation target point and to a RGB input value of the computation reference point; an image processing unit for detecting whether the RGB input value of the computation target point is located within the range of the image reading signals; and a control unit for controlling creation of the 3D color information conversion table based on a detecting result by the image processing unit;
wherein the control unit allows the interpolation processing unit to execute interpolation processing, when the RGB input value of the computation target point detected by the image processing unit is located within the range of the image reading signals, and allows the extrapolation processing unit to execute extrapolation processing, when the RGB input value of the computation target point is located outside the range the image reading signals.

(2). An image processing method for creating a 3D color information conversion table for converting a color image signal of one signal processing system into a color image signal of the other signal processing system, based on: color measurement signals obtained by color measuring of a reference color original where N-fold N² pieces of reference color images are arranged in such a way that respective intensities of red, green and blue (RGB) of the reference color images are increased in order; and image reading signals obtained by reading the reference color originals through light exposure scanning; the image processing method having: an interpolation processing mode for obtaining output values of the color measurement signals corresponding to RGB input values on four apexes enclosing a RGB input value of a computation target point, when the image reading signals are expanded on the color 3D coordinate system to express the RGB input value for creating the 3D color information conversion table; and an extrapolation processing mode for extracting a computation reference point out of the image reading signals expressed on the color 3D coordinate system, fixing the computation reference point, connecting between the computation reference point and the computation target point, and thereby obtaining the output values of the color measurement signal corresponding to RGB input values of three apexes enclosing the RGB input value of the computation target point and to a RGB input value of the computation reference point; wherein the image processing method including the steps of: detecting whether the RGB input value of the computation target point is located within the range of the image reading signals; executing interpolation processing when the RGB input value of the computation target point is located within the range of the image reading signals, and executing extrapolation processing when the RGB input value of the computation target point is located outside the range the image reading signals.

(3). The color image forming apparatus for forming a color image based on color image signals of a YMCK (yellow, magenta, cyan and black) signal processing system obtained by conversion from color image signals of a RGB (red, green and blue) signal processing system, the color image forming apparatus including: a color conversion unit for converting inputted color image information of the RGB signal processing system into color image information of the YMCK signal processing system; and an image forming unit for forming the color image based on the color image information of the YMCK signal processing system having undergone color conversion by the color conversion unit; wherein the 3D color information conversion table created by the image processing apparatus of configulation (1) is applied to the color conversion unit.

(4). The color image forming apparatus for forming a color image based on color image signals of a YMCK (yellow, magenta, cyan and black) signal processing system obtained by conversion from color image signals of a RGB (red, green and blue) signal processing system, the color image forming apparatus including: a color conversion unit for converting inputted color image information of the RGB signal processing system into color image information of the YMCK signal processing system; and an image forming unit for forming the color image based on the color image information of the YMCK signal processing system having undergone color conversion by the color conversion unit; wherein the 3D color information conversion table created by the image processing method of configuration (2) is applied to the color conversion unit.

(5). An image processing apparatus for creating a 3D color information conversion table for converting a color image signal of one signal processing system into a color image signal of the other signal processing system, based on: color measurement signals obtained by color measuring of a reference color original where N-fold N² pieces of reference color images are arranged in such a way that respective intensities of red, green and blue (RGB) of the reference color images are increased in order; and image reading signals obtained by reading the reference color originals through light exposure scanning; the image processing apparatus including an extrapolation processing unit for extracting a computation reference point out of the image reading signals expressed on the color 3D coordinate system, fixing the computation reference point, connecting between the computation reference point and the computation target point, and thereby obtaining the output values of the color measurement signal corresponding to RGB input values of three apexes enclosing the RGB input value of the computation target point and to a RGB input value of the computation reference point.

### BRIEF DESCRIPTION OF THE DRAWINGS

FIG. 1 is a block diagram representing an example of the configuration of the image processing apparatus 100 as a first embodiment of the present invention;

FIG. 2 is a conceptual diagram representing an example of the configuration of a patch original 80;

FIG. 3 is a G-R color gradation lattice diagram representing an example of plotting the scanner signal;

FIG. 4 is a G-R color gradation lattice diagram showing an example of a color gamut lattice in the extrapolation processing mode;

FIGS. 5(a) and (b) are drawings showing examples of the settings of triangular pyramids I and II in the extrapolation or interpolation processing mode;

FIG. 6 is a drawing showing an example (9th stage) of setting the center RGB input values in an RGB color coordinate system;

FIG. 7 is a drawing showing an example (17th stage) of setting the center RGB input values in an RGB color coordinate system;

FIG. 8 is a drawing showing an example (25th stage) of setting the center RGB input values in an RGB color coordinate system;

FIG. 9 is a flowchart representing an example of creating a 3D-LUT in the image processing apparatus 100;

FIG. 10 is a flowchart representing an example of processing a triangular set;

FIG. 11 is a flowchart representing an example of processing a triangular pyramid set;

FIGS. 12(a) and (b) are drawings showing the examples of evaluation and color conversion patterns when a color is converted from green (G) to magenta (M) in the present invention;

FIGS. 13(a) and (b) are drawings representing the comparative examples (Nos. 1 and 2) of evaluating the color conversion from G to M;

FIGS. 14(a) and (b) are drawings representing the comparative examples (Nos. 3 and 4) of evaluating the color conversion from G to M;

FIG. 15 is a drawing showing an example of evaluating the smoothness in color conversion from green (G) to magenta (M) in the present invention;

FIGS. 16(a) and (b) show comparative examples (Nos. 1 and 2) of evaluating the smoothness in color conversion from green (G) to magenta (M) in the present invention;

FIGS. 17(a) and (b) show comparative examples (Nos. 3 and 4) of evaluating the smoothness in color conversion from green (G) to magenta (M) in the present invention;

FIG. 18 is a conceptual diagram showing an example of the cross sectional view of a color printer 200 as a second embodiment in the present invention;

FIG. 19 is a block diagram showing an example of the internal configuration of a printer 200;

FIG. 20 is a flowchart representing the operation of the printer 200;

FIG. 21 is a block diagram representing an example of the configuration of a printer 300 as a third embodiment in the present invention; and

FIG. 22 is a G-R color gradation lattice diagram showing an example of a color gamut lattice in the prior art extrapolation processing mode.

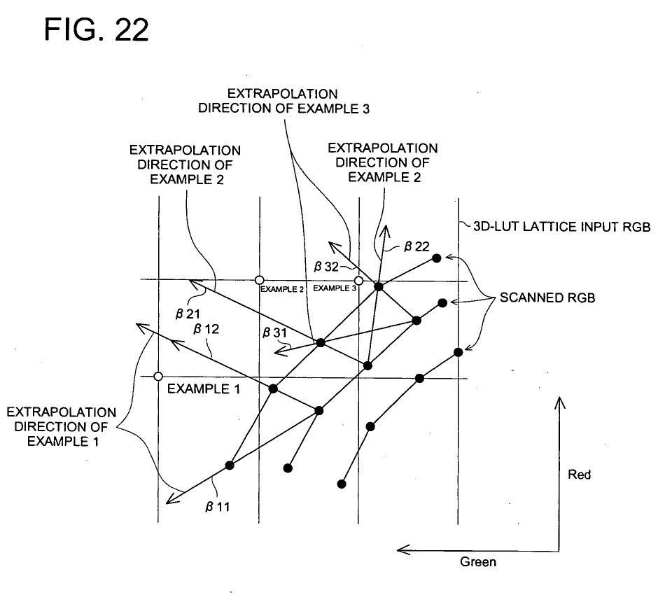

### DETAILED DESCRIPTION OF THE PREFERRED EMBODIMENT

Referring to the drawings, the following describes the image processing apparatus, image processing method and image forming apparatus as an embodiment of the present invention:

### Embodiment 1

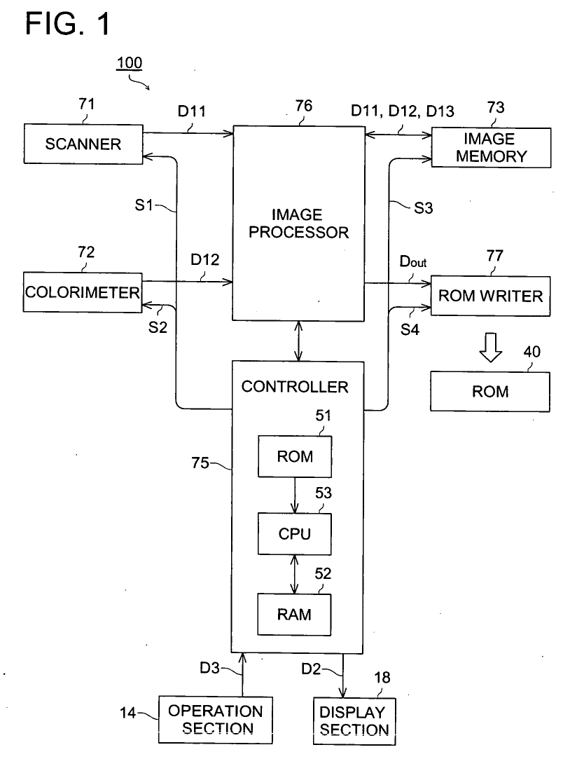

FIG. 1 is a block diagram representing an example of the configuration of the image processing apparatus 100 as a first embodiment of the present invention.

The image processing apparatus 100 in FIG. 1 creates a 3D color information conversion table (hereinafter referred to as “3D-LUT”) for converting the color image signals of red (R), green (G) and blue (B) of one signal processing system (hereinafter referred to as “RGB signal processing system”), into the color image signals of yellow (Y), magenta (M), cyan (C) and black (K) of another signal processing system (hereinafter referred to as “YMCK signal processing system”), based on;
the color measurement signal obtained by measuring the patch original 80 where N-fold N²-reference color images (hereinafter referred to as “color patch”) are arranged in such a way that the intensities of the red, green and blue (RGB) are increased; and
the image reading signal (hereinafter referred to as “scanner signal”) obtained by scanning the patch original 80.

The image processing apparatus 100 contains a color scanner 71, calorimeter 72, image memory 73, operation section 74, controller 75, image processor 76, ROM writer 77 and display section 78. The controller 75 is equipped with a ROM (Read Only Memory) 51, RAM (Random Access Memory) 52 and CPU (Central Processor Unit) 53. The ROM 51 stores a system program data for control the entire image forming apparatus. The RAM 52 is used as a work memory, and stores the control command on the temporary basis, for example. When power is turned on, the CPU 53 reads system program data from the ROM 51 and starts the system. Based on the operation data D3 from the operation section 74, the CPU 53 controls the entire image forming apparatus.

The scanner 71 is connected to the controller 75 and image processor 76 and the patch original 80 where N-fold N² color patches are arranged is scanned and exposed to light in conformity to the scanning control signal S1, thereby producing a scanner signal. The scanner signal is subjected to analog-to-digital conversion, for example, inside the scanner, and is turned into scanner data D11. The scanner data D11 is outputted to an image processing section 76 and is assigned with an RGB value. The scanning control signal S1 is outputted to the scanner 71 from the controller 75. The scanner 71 used is equipped with an 8-bit (256 gradations) output function.

The calorimeter 72 is connected to the controller 75 and image processing section 76. The color of each color patch of the patch original 80 is measured according to the color measurement control signal S2, thereby generating XYZ color measurement signals. The XYZ color measurement signals are subjected to analog-to-digital conversion, for example, in the calorimeter 72, and are turned into XYZ color measurement data D12. The color measurement control signal S2 is outputted from the controller 75 to the calorimeter 72. The XYZ color measurement data D12 is outputted to the controller 75 and is used to calculate the Lab output value corresponding to the computation target point P in.

The controller 75 sets the RGB input values of the 3D-LUT for calculating the Lab output value corresponding to the computation target point P in. It also sets the scanned RGB values in the image processing section 76. For example, the 125-color scanner data D11 obtained from the scanner 71 and the XYZ 125-color color measurement data D12 obtained from the calorimeter 72 are sent to the image processing section 76. When the R-color matrix elements obtained from the scanner data D11 are R₁ through R₁₂₅, the G-color matrix elements are G₁ through G₁₂₅, the B-color matrix elements are B₁ through B₁₂₅, the X color measurement matrix elements obtained from the XYZ color measurement data D12 are X₁ through X₁₂₅; the Y color measurement matrix elements are Y₁ through Y₁₂₅, and the Z color measurement matrix elements are Z₁ through Z₁₂₅, the image processing section 76 executes the 3-row by 3-column matrix calculation formula (1′) as shown below:

$$\begin{matrix}[ Eq . 4 ] & {( 1 )}^{′} \\ [ \begin{matrix}X \\ Y \\ Z\end{matrix} ] = [ \begin{matrix}a & b & c \\ d & e & f \\ g & h & i\end{matrix} ] \times [ \begin{matrix}R \\ G \\ B\end{matrix} ] & \\ [ \begin{matrix}{X}_{1} & {X}_{2} , & … & , {X}_{125} \\ {Y}_{1} & {Y}_{2} , & … & , {Y}_{125} \\ {Z}_{1} & {Z}_{2} , & … & , {Z}_{125}\end{matrix} ] = A \cdot [ \begin{matrix}{R}_{1} & {R}_{2} , & … & , {R}_{125} \\ {G}_{1} & {G}_{2} , & … & , {G}_{125} \\ {B}_{1} & {B}_{2} , & … & , {B}_{125}\end{matrix} ] & \\ T = A \cdot S & {( 2 )}^{′} \\ T \cdot {S}^{t} = A \cdot S \cdot {S}^{t} & \\ T \cdot {S}^{t} \cdot {( S \cdot {S}^{t} )}^{- 1} = A \cdot S \cdot {S}^{t} \cdot {( S \cdot {S}^{t} )}^{- 1} & \\ A = T \cdot {S}^{t} \cdot {( S \cdot {S}^{t} )}^{- 1} & \end{matrix}$$

Then the matrix coefficient A is obtained from Eq. (2)′. The matrix coefficient A consists of a, b, c, d, e, f, g, h and i. According to Eq. (3)′, the controller 75 converts the 125-color XYZ color measurement data D12 into the lightness/chromaticity data (hereinafter referred to as “Lab data D13”) of the L*-C* coordinate system (lightness/chromaticity 3D coordinate system).

$$\begin{matrix}[ Eq . 5 ] & {( 3 )}^{′} \\ L = 116 \times {( \frac{Y}{{Y}_{n}} )}^{\frac{1}{3}} - 16 & \\ a = 500 \times \{ {( \frac{X}{{X}_{n}} )}^{\frac{1}{3}} - {( \frac{Y}{{Y}_{n}} )}^{\frac{1}{3}} \} & \\ b = 500 \times \{ {( \frac{Y}{{Y}_{n}} )}^{\frac{1}{3}} - {( \frac{Z}{{Z}_{n}} )}^{\frac{1}{3}} \} & \end{matrix}$$

The Lab data D13 contains such Lab values as lightness L* and chromaticity a* and b*. The chromaticity a* is red when a* is in the positive direction, and is green when a* is in the negative direction. Chromaticity b* is yellow when in the positive direction is blue when in the negative direction. Lightness L*, chromaticity a* and chromaticity b* are expressed in the lightness/chromaticity coordinate system (hereinafter referred to as “Lab color coordinate system”). The scanner data D11, XYZ color measurement data D12 and Lab data D13 are stored in the image memory 73 in response to the memory control signal S3. The memory control signal S3 is outputted to the image memory 73 from the controller 75. A hard disk or DRAM is used as the image memory 73. In this example, the 8-bit RGB input values, viz., 256 gradations are separated for eight each gradations and are divided into 33 steps. Then 0 through 32 are set for each. The RGB value of this scan data (scanner signal) D11 is assumed as P in_{RGB} and the Lab value of the Lab data D13 are assumed as Q in_{Lab}.

The operation section 74 is operated in such a way as to select the gradation number equal in terms of each RGB axis of the color 3D coordinate system obtained from the patch original 80, for example. This operation for selection is intended to set the RGB input values of the computation reference point P center. The data set by the operation section 74 is outputted to the controller 75 in the form of operation data D3. Based on the operation data D3, the color 3D coordinate system or the like is displayed on the display section 78.

The controller 75 sets the center RGB values to the image processing section 76. This example refers to the case wherein the center RGB values of the computation reference point P center are set to R=G=B=17th stage, out of the lattice point of 33 stages. The center RGB values do not necessarily be set to the 17th stage. The center RGB values can be set to other stages. The scanned RGB value of the computation reference point P center is assumed as P center_{RGB}, and the Lab value thereof is assumed as Q center_{Lab}.

The controller 7 is connected with the image processing section 76. The image processing section 76 is composed of a DSP (Digital Signal Processor) and RAM, for example, in this example, the image processing section 76 applies processing of color gamut surface search. This color gamut surface search is intended to find out which surface, out of the color gamut surfaces of the scanner data D11, intersects the straight line connecting between the RGB input values of the computation target point P in and center RGB value of the computation reference point P center. The surface providing the minimum unit, out of the color gamut surfaces, is a triangle consisting of three pieces of scanner data D11.

For example, the image processing section 76 is inputted into the scanner data D11 and is subjected to processing of triangle setting. In this case, a plurality of triangles are sequentially set. The apexes of the triangles set in this case are assumed as P1, P2 and P3, and the scanned RGB values are assumed as P1_{RGB}, P2_{RGB} and P3_{RGB}. Their Lab values are assumed as Q1_{Lab}, Q2_{Lab} and Q3_{Lab}.

The image processing section 76 performs intersection decision processing in addition to triangle set processing. The intersection decision processing in the sense in which it is used here refers to the processing of determining which surface, out of the color gamut surfaces of the scanner data D11, intersects the straight line connecting between the RGB input values of the computation target point P in and the center RGB values of the computation reference point P center.

In addition to the aforementioned intersection decision processing, the image processing section 76 inputs the scanner data D11 and performs triangular pyramid set processing. For example, the lattice points having the volume of the minimum unit, out of the 5³ pieces of scanner data D11, is four lattice points constituting the triangular pyramid. In this example, the four lattice points are sequentially set by the image processing section 76. The four lattice points constituting the triangular pyramid are assumed as P4, P5, P6 and P7 and the scanned RGB values of these lattice points are assumed as P4_{RGB}, P5_{RGB}, P6_{RGB} and P7_{RGB}. Their Lab values are assumed as Q4_{Lab}, Q5_{Lab}, Q6_{Lab} and Q7_{Lab}.

The image processing section 76 performs inclusion decision processing. The inclusion decision processing is defined as the processing of determining whether or not the RGB input values of the computation target point P in are included in the plotting range of the scanned RGB values. In addition to the inclusion decision processing, the image processing section 76 inputs the scanner data D11 and checks whether or not the RGB input values of he computation target point P in are present in the range of the scanned RGB values.

The image processing section 76 performs the gamut inside/outside decision processing. This process determines if the RGB input values of the computation target point P in are inside the color gamut or not, based on the coefficients a, b and c gained from the intersection decision processing. In this case, if the a+b+c<0 as a decision condition is met, the controller 75 determines that the computation target point P in is located inside the color gamut. If the a+b+c<0 is not met, the controller 75 determines that the computation target point P in is located outside the color gamut.

Based on the result of detection gained from the image processing section 76, the controller 75 controls the creation of the 3D-LUT. For example, if the RGB input values of the computation target point P in detected by the image processing section 76 is located inside the range of the scanner data D11, the controller 75 applies interpolation processing mode. If the RGB input values of the computation target point P in is located outside the range of the scanner data D11, the controller 75 applies extrapolation processing mode.

The interpolation processing mode in the sense in which it is used here refers to the process of finding out the Lab output value of the color measurement signal corresponding to the scanned RGB values of four lattice points enclosing the RGB input values of the computation target point P in, when the scanned RGB values are expressed by expanding the scanner signal on the color 3D coordinate system for creating the 3D-LUT.

The extrapolation processing mode in the sense in which it is used here refers to the process of finding out the scanned RGB values of three apexes enclosing the RGB input values of the computation target point P in, and the Lab output value of the color measurement signal corresponding to the scanned RGB values of computation reference point P center. This is carried out by extracting the computation reference point P center from the scanner signal expressed in the RGB color 3D coordinate system and fixing the computation reference point P center in position, and by using a straight line to connect between the computation reference point P center and computation target point P in.

The controller 75 provides interpolation by computing the Lab output values of the Lab color coordinate system corresponding to the RGB input values of the computation target point P in. Further, based on the operation data D3 gained from the operation section 74, the controller 75 selects the gradation number equal in terms of each RGB axis of the color 3D coordinate system obtained from the patch original 80 wherein N-fold N² color patches are arranged, whereby the scanned RGB values of the computation reference point P center is set.

The ROM writer 77 is connected to the controller 75 and image processing section 76. In response to the ROM write signal S4 and ROM data D out, the ROM writer 77 writes the 3D-LUT into the mask ROM and creates an RGB→Lab 3D-LUT and RGB→YMCK 3D-LUT. The ROM write signal S4 is outputted to the ROM writer 77 through the controller 75.

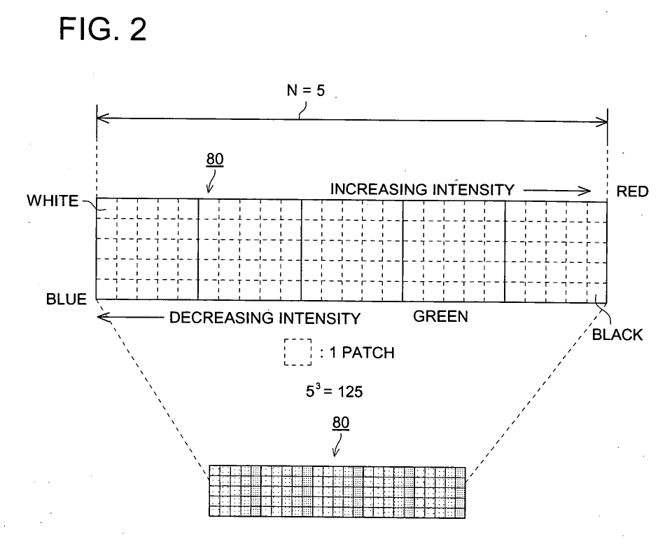

FIG. 2 is a conceptual diagram showing an example of configuration of the patch original 80. This example refers to the case of creating a 3D color information conversion table (hereinafter referred to as “RGB→Lab 3D-LUT”), whereby the color image signal (RGB) related to the R, G and B of the RGB signal processing system is converted into the color image signal (Lab) related to the color L (luminance), color a and color b of the lightness/chromaticity coordinate system (hereinafter referred to as “Lab signal processing system”).

In this case, use of made of a patch original 80 where five 5×5 color patches are arranged so that the hue is changed in N=5 stages as shown in FIG. 2, viz., the intensity of each of three RGB colors is increased. For example, a white color is located on the left top corner of the patch original 80, and a black color is found on the right bottom corner on the diagonal line thereof. On the top, the intensity of red is greater as one goes to the right. On the bottom, the intensity of blue is increased as one goes to the left. By contrast, the intensity of green is increased as one goes to the right.

In the image processing apparatus 100, the RGB→Lab 3D-LUT is created based on the measurement value (Lab and XYZ) of the patch original 80 and scanner signal (RGB). The RGB→Lab 3D-LUT is a table for converting the RGB to the Lab. For each of the RGB, for example, when the 8-bit RGB input values, viz., 256 gradations are separated for eight each gradations and are divided into 33 stages, then 0 through 32 are set for each. The Lab output value is stored in the color 3D coordinate space of the 33 stages.

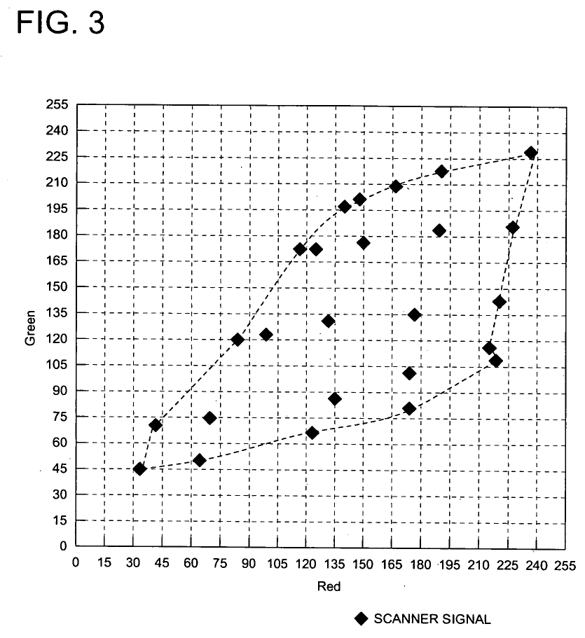

FIG. 3 is a G-R color gradation lattice diagram representing an example of plotting the scanner signal. It shows the relationship between the two-dimensional lattice point and G and R-color gradation values (scan values). The vertical axis given in FIG. 3 indicates the gradation value of the eight-bit (2⁸=256 gradations) G-color scanner signal gained from the scanner data D11, and represents 0 through 255. Similarly, the horizontal axis shows the 8-bit R-color gradation value, and represents 0 through 255. The 25 rhombic black marks are gained by plotting the scanner signals obtained by reading the 5³ color patches and formed into a G-R color gradation lattice diagram.

It can be seen that the range of the scanner signal plot does not cover the entire range of the 0 through 255 of the scanner 71. In this example, when the rhombic black marks located outmost portion of the scanner signal plotted on the G-R color gradation lattice diagram are connected to form an annular line, the lattice point located inside the annular line is treated in such a way that the Lab output value is subjected to interpolation in conformity to the interpolation processing mode (interpolation method).

And the lattice point located outside the annular line is treated in such a way that the Lab output value is subjected to extrapolation in conformity to the extrapolation processing mode (extrapolation method).

In this processing, the Lab output value is subjected to interpolation according to the Lab values corresponding to the scanned RGB values at three positions closest to that position, with respect to the RGB input values as the computation target point P in. A triangle is formed by selecting three rhombic black marks in FIG. 3 and connecting apexes thereof.

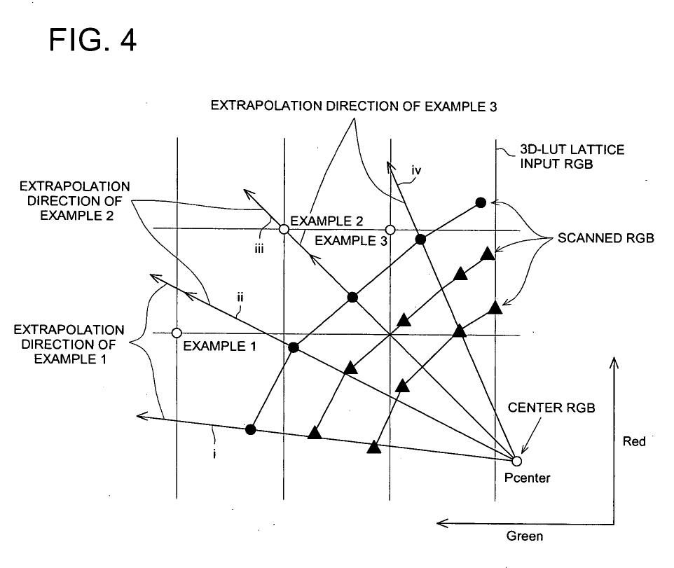

FIG. 4 is a G-R color gradation lattice diagram showing an example of a color gamut lattice in the extrapolation processing mode. The example of a color gamut lattice given in FIG. 4 is a schematically enlarged view of the peripheral portion of the color gamut of the computation target point. It represents the R-G color coordinate system (2D) extracted from the 3D coordinate system. This example provides a two-dimensional representation of the scanned RGB values and RGB input values.

The vertical line of the FIG. 4 shows the G-color lattice (gradation) line providing the 3D-LUT lattice point. Similarly, the horizontal line shows the R-color lattice (gradation) line. The black marks are obtained by plotting the scanned RGB values and are connected with each other by a solid line. The black triangular marks are gained by plotting other scanned RGB values, and are connected with each other by a solid line.

Examples 1 through 3 given in FIG. 4 represent the computation target point set on the lattice point of the R-G color coordinate system. The RGB input values of the computation target point are given in terms of the RGB input values of the 3D-LUT lattice points. In the present invention, the scanned RGB values located inside the plot range of the scanner signal are set and fixed at the center of the color gamut. This is intended to solve the intersection problem with the extrapolation vector.

As described above, in the extrapolation processing mode if setting is made in such a way that the scanned RGB values are fixed at the center of the color gamut, the extrapolation vectors i through iv of the computation target points P in with respect to the RGB input values do not intersect with each other. A smooth change can be observed when viewed in the order of examples 1, 2 and 3 of the computation target points. This ensures a continuity in Lab output values.

The extrapolation vector i represents a straight line connecting between the computation reference point P center and one scanned RGB value. The extrapolation vector ii represents a straight line connecting between the scanned RGB value of the computation reference point P center and another scanned RGB value adjacent to the extrapolation vector i. The extrapolation vector iii represents a straight line connecting between computation reference point P center and another scanned RGB value adjacent to the extrapolation vector ii. The extrapolation vector iv represents a straight line connecting between the computation reference point P center and another scanned RGB value adjacent to the extrapolation vector iii.

In this example, vectors i and ii radiate in the direction of extrapolation and a computation target point 2 is present between them. Vectors ii and iii radiate in the direction of extrapolation in Example 2, and a computation target point 2 is present between them. Vectors iii and Iv radiate in the direction of extrapolation in Example 3, and a computation target point 3 is present between them. In the prior art method, computation in the extrapolation processing mode has been carried out in the XYZ 3D color coordinate system. In the present invention, by contrast, computation is carried out in the Lab 3D color coordinate system, thereby improving the linearity in the Lab space where smoothness is evaluated.

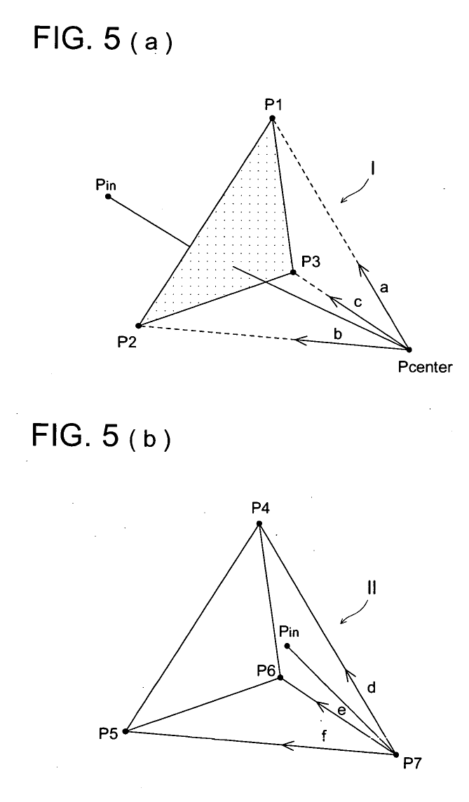

FIGS. 5(a) and (b) are drawings showing examples of the settings of triangular pyramids I and II in the extrapolation or interpolation processing mode. The triangular pyramid I in FIG. 5(a) is composed of apexes P1, P2 and P3 and P center.

In this example, when the scanned RGB values are located outside the plot range shown in FIG. 4, a straight line is used to connect between the center RGB of the computation reference point P center located at the center in the scanner signals and the RGB input values of the computation target point P in. Four apexes for obtaining the Lab output value are triangular pyramid, from the triangle obtained from the relationship of intersection with the outside of the scanner signal. The relationship of distance between the scanned RGB of the triangular pyramid and the RGB input values, and the Lab output value with respect to the RGB input values from the Lab value of each apex of the triangular pyramid is obtained.

To be more specific, in the extrapolation processing mode, a vector radiates from the computation reference point P center toward the computation target point P in. In this example, if there is any intersection between the computation target point P in_{RGB}, computation reference point P center_{RGB}, apexes P1_{RGB}, P2_{RGB} and P3_{RGB}, then the relationship between apexes can be calculated from the following Equation (4):

$$P {in}_{RGB} - P {center}_{RGB} = a \times ( {P1}_{RGB} - P {center}_{RGB} ) + b \times ( {P2}_{RGB} - P {center}_{RGB} ) + c \times ( {P3}_{RGB} - P {center}_{RGB} ) \qquad ( 4 )$$

Arrangement should be made so that this calculation is carried out by the DSP of the image processing section 76 or CPU 53 inside the controller 75. In this example, coefficients a, b, and c connecting between the left and right sides of Equation (4) are calculated. A decision is made in such a way that, when the values of these coefficients a, b and c meet the conditions of a>0, b>0 and c>0, then the straight line connecting between the RGB input values of the computation target point P in and center RGB values of the computation reference point P center intersects the color gamut surface of the scanner data D11; and when the aforementioned condition is not met, the line does not intersect the color gamut surface. This intersection decision processing is applied so that search loop is repeated until the aforementioned condition is met. This procedure allows the RGB→Lab 3D-LUT to be created by the extrapolation method.

The triangular pyramid II shown in FIG. 5(b) is composed of apexes P4, P5, P6 and P7. In this example, when the RGB input values of the lattice points of the 3D-LUT are located inside the plot range of the scanner signal, then the Lab output value of the computation target point P in with respect to the RGB input values is obtained from the relationship of the distance relative to the scanned RGB values of the triangular pyramid II enclosing the RGB input values and the lab values of the apexes of the triangular pyramid II.

To be more specific, in the interpolation processing mode, a vector radiates towards one apex within the plot range of the scanner signal, for example, toward the computation target point P in of the P7, and the computation target point P in_{RGB} is included in the triangular pyramid II wherein the computation target point P in_{RGB} contains the apexes P4_{RGB}, P5_{RGB}, P6_{RGB} and P7_{RGB}. The relationship between apexes of the triangular pyramid II in this case, can be calculated from the Eq. (5):

$$P {in}_{RGB} - {P7}_{RGB} = d \times ( {P4}_{RGB} - {P7}_{RGB} ) + e \times ( {P5}_{RGB} - {P7}_{RGB} ) + f \times ( {P6}_{RGB} - {P7}_{RGB} ) \qquad ( 5 )$$

The configuration should be made in such a way that this calculation is carried out by the DSP of the image processing section 76 or the CPU 53 inside the controller 75. In this example, coefficients d, e and f are calculated. A decision is made in such a way that, if coefficients d, e and f meet the condition d+e+f<1, then the RGB input values of the computation target point P in is included in the plot range of the scanned RGB values; and if not, the RGB input values is not included in the plot range. In this inclusion decision processing, the search loop is repeated until the aforementioned conditions is met. This procedure allows the RGB→Lab 3D-LUT to be created.

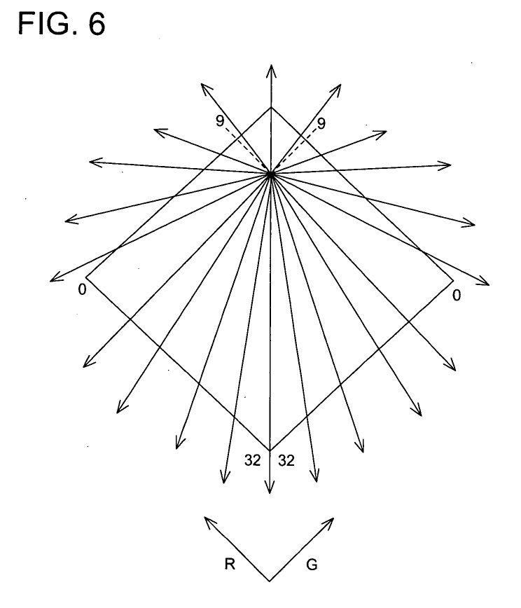

FIG. 6 is a drawing showing an example (9th stage) of setting the center RGB input values in an RGB color coordinate system. In this example, control is provided in such a way as to select the gradation number equal in terms of each RGB axis of the color 3D coordinate system obtained from the patch original 80 where five 5×5 color patches are arranged, whereby the RGB input values of the computation reference point P center is set.

The example of the color gamut shown in FIG. 6 is taken by extracting the R-G color coordinate system from the 3D coordinate system, where the scanned RGB values and RGB input values are represented in two-dimensional terms. In this example, the 8-bit RGB input values, viz., 256 gradations are separated for eight each gradations and are divided into 33 stages. Then 0 through 32 are set in the R-G color coordinate system. This example shows how the extrapolated vector radiates when the center RGB values are set to R=G B=9th stage. The extrapolated vectors are radiated in such a way that the distance between vectors is increased at a higher position, and is decreased at a lower position.

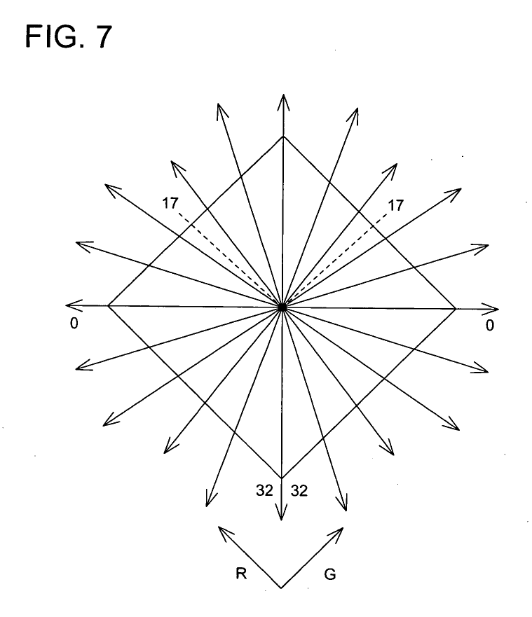

FIG. 7 is a drawing showing an example (17th stage) of setting the center RGB input values in an RGB color coordinate system. This example shows how the extrapolated vector radiates when the center RGB values are set to R=G=B=17th stage. The extrapolated vectors are radiated in such a way that the distance between vectors is kept almost unchanged.

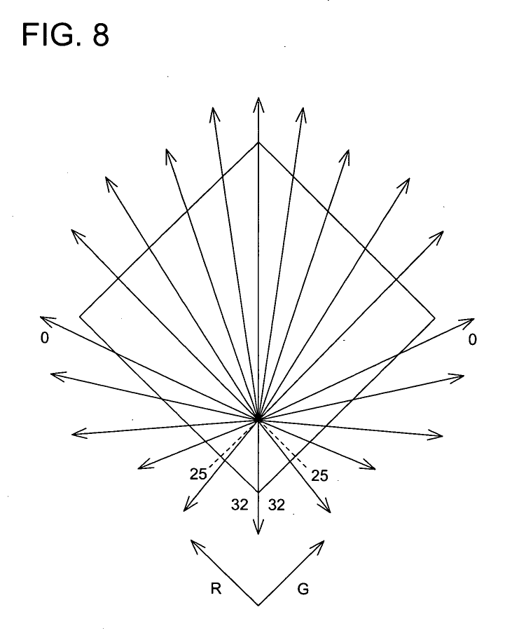

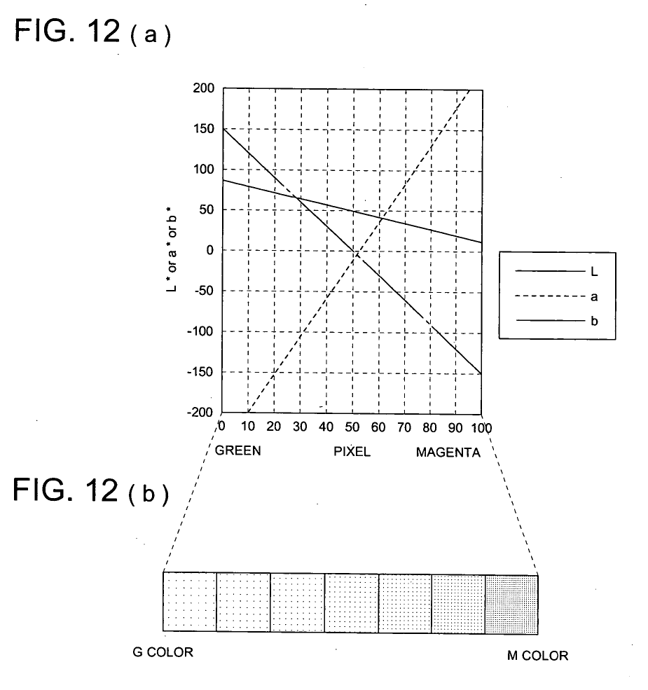

FIG. 8 is a drawing showing an example (25th stage) of setting the center RGB input values in an RGB color coordinate system. This example shows how the extrapolated vector radiates when the center RGB values are set to R=G=B=25th stage. The extrapolated vectors are radiated in such a way that the distance between vectors is decreased at a lower position, and is increased at a higher position. It can be seen that the direction of the extrapolation is changed according to the ordinal position of the stage in which the center RGB values are set. Smoothness is varied according to the change in the direction of extrapolation, as shown in FIG. 12.

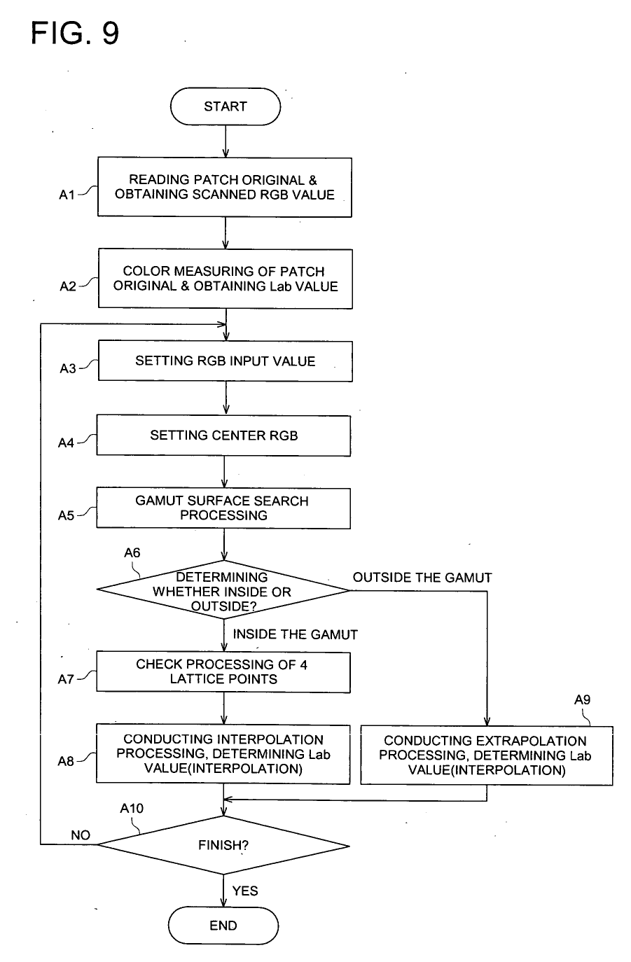

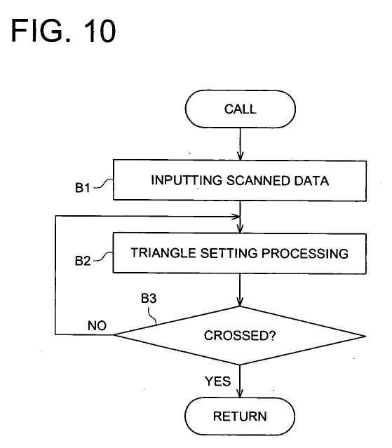

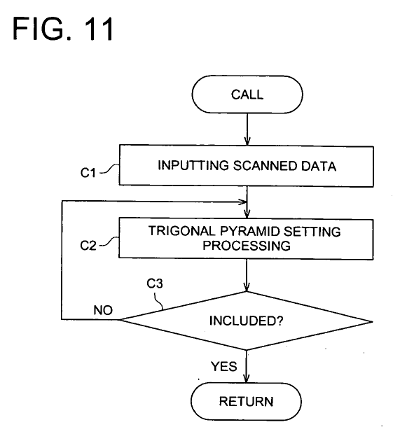

The following describes the image processing method of the present invention: FIG. 9 is a flowchart representing an example of creating a 3D color information conversion table in the image processing apparatus 100. FIG. 10 is a flowchart representing an example of processing a triangular set, and FIG. 11 is a flowchart representing an example of processing a triangular pyramid set.

This embodiment will be described with reference to the case of creating a 3D-LUT for converting the color image signal of the RGB signal processing system into the color image signal of the YMCK signal processing system;
from the Lab input value obtained by measuring the color of the patch original 80 where five 5×5 reference color images are arranged in such a way that the intensities of the red, green and blue (RGB) are increased, and
from the scanned RGB values obtained by scanning the patch original 80 (image processing method).

In Step A1 of the flowchart shown in FIG. 10, the patch original 80 is scanned to get the scanned RGB values. In this case, an operator sets the patch original 80 on the scanner 71. The scanner 71 scans the patch original 80 set thereon according to the scanning control signal S1 and outputs the scanner data D12 to the image processing section 76.

Then the color of the patch original 80 is measured to get the Lab value. In this case, the operator sets the patch original 80 on the calorimeter 72. The calorimeter 72 measures the color of the patch original 80 set thereon according to the color measurement control signal S2 and outputs the XYZ color measurement data D11 to the image processing section 76.

In the Step A3, the controller 75 sets the RGB input values of the 3D-LUT for calculating the Lab output value corresponding to the computation target point P in. The controller 75 also sets the scanned RGB values on the image processing section 76. For example, the controller 75 provides control so that the scanner data D11 obtained from the scanner 71 and the XYZ 125-color measurement data D12 obtained from the colorimeter 72 are sent to the image processing section 76. The image processing section 76 allows the following elements to be substituted into the aforementioned Eq. (1)′, viz., the 3×3 matrix calculation equation; the R-color matrix elements R₁ through R₁₂₅, G-color matrix elements G₁ through G₁₂₅ and B-color matrix elements B₁ through B₁₂₅ obtained from the scanner data D11; and X-color matrix elements X₁ through X₁₂₅, Y-color matrix elements Y₁ through Y₁₂₅, Z-color matrix elements Z₁ through Z₁₂₅ obtained from the scanner data D11, whereby the matrix coefficient A is calculated from the Eq. (2)′. The matrix coefficients A are a, b, c, d, e, f, g, h and i.

According to the aforementioned Eq. (3)′, the controller 75 converts the XYZ 125-color measurement data D12 into the Lab data D13 of the L*-C* coordinate system. The scanner data D11, XYZ color measurement data D12 and Lab data D13 are stored in the image memory 73.

In this example, the 8-bit RGB input values, viz., 256 gradations are separated for eight each gradations and are divided into 33 stages. Then 0 through 32 are set for each. The RGB values of this scanner data D11 are assumed as P in_{RGB}, and the Lab value of the Lab data D13 is assumed as Q in_{Lab}.

In the Step A4, the controller 75 sets the center RGB values to the image processing section 76. This example refers to the case wherein the center RGB values as the computation reference points P center are set to R=G=B=17th stage, out of the lattice point of 33 stages. The center RGB values do not necessarily be set to the 17th stage. The center RGB values can be set to other stages. The scanned RGB value of the computation reference point P center is assumed as P center_{RGB}, and the Lab value thereof is assumed as Q center_{Lab}.

In the Step A5, the image processing section 76 applies the process of color gamut surface search. In this example, the color gamut surface search is performed to find out which surface, out of the color gamut surfaces of the scanner data D11, intersects the straight line connecting between the RGB input values of the computation target point P in and center RGB value of the computation reference point P center. The surface providing the minimum unit, out of the color gamut surfaces, is a triangle consisting of three pieces of scanner data D11. A triangle is formed by connecting three rhombic black marks shown in FIG. 3.

For example, calling the subroutine shown in FIG. 10, the image processing section 76 enters the scanner data D11 in the Step B1. In the Step B2, triangle setting processing is applied. In this case, triangles are sequentially set out of a plurality of triangles. The apexes of the triangles set in this Step are assumed as P1, P2 and P3, and the scanned RGB values are assumed as P1_{RGB}, P2_{RGB} and P3_{RGB}, where Lab values are Q1_{Lab}, Q2_{Lab} and Q3_{Lab}. Then the system goes to Step B3, where the image processing section 76 performs intersection decision processing.

The intersection decision processing in the sense in which it is used here refers to the processing of determining which surface, out of the color gamut surfaces of the scanner data D11, intersects the straight line connecting between the RGB input values of the computation target point P in and the center RGB values of the computation reference point P center. If there is any intersection between the computation target point P in_{RGB}, computation reference point P center_{RGB}, computation reference point P center_{RGB}, and apexes P1_{RGB}, P2_{RGB} and P3_{RGB}, then the relationship between apexes can be calculated from the following Equation (4):

$$P {in}_{RGB} - P {center}_{RGB} = a \times ( {P1}_{RGB} - P {center}_{RGB} ) + b \times ( {P2}_{RGB} - P {center}_{RGB} ) + c \times ( {P3}_{RGB} - P {center}_{RGB} ) \qquad ( 4 )$$

In this example, coefficients a, b and c connecting between the right and left sides of Eq. 4 are calculated. In this case, a decision is made in such a way that, if the coefficients a, b and c meet the conditions a>0, b>0 and c>0, then a straight line connecting between the RGB input values of the computation target point P in and the center RGB values of the computation reference point P center intersects the color gamut surface of the scanner data D11; and if these conditions are not met, the straight line does not intersect the color gamut surface. In this intersection decision processing, the search loop is repeated until the aforementioned conditions are met.

Upon completion of the aforementioned intersection decision processing, the system goes back to the Step A5 of the main routine. After that, the sub-routine shown in FIG. 11 is called and the scanner data D11 is inputted in step C1. In step C2, the triangular pyramid set processing is executed. For example, the lattice points having the volume of the minimum unit in the 5³ scanner data D11 are the four-lattice points constituting the triangular pyramid. In this case, the four-lattice points are sequentially set by the image processing section 76. The four lattice points constituting this triangular pyramid are assumed as P4, P5, P6 and P7, and the scanned RGB values of the lattice points are assumed as P4_{RGB}, P5_{RGB}, P6_{RGB} and P7_{RGB}, where Lab values are Q4_{Lab}, Q5_{Lab}, Q6_{Lab} and Q7_{Lab}, respectively.

In the Step C3, the image processing section 76 performs inclusion decision processing. The inclusion decision processing in the sense in which it is used here refers to the process of determining if the RGB input values of the computation target point P in are included in the plot range of the scanned RGB values. For example, it refers to the case where the computation target point P in_{RGB} is included in the triangular pyramid containing the apexes P4_{RGB}, P5_{RGB}, P6_{RGB} and P7_{RGB}, as shown in FIG. 5(b). In this case, the relationship between apexes of the triangle is expressed in the following Eq. (5):

$$P {in}_{RGB} - {P7}_{RGB} = d \times ( {P4}_{RGB} - {P7}_{RGB} ) + e \times ( {P5}_{RGB} - {P7}_{RGB} ) + f \times ( {P6}_{RGB} - {P7}_{RGB} ) \qquad ( 5 )$$

In this example, the coefficients d, e and f are calculated. In this case, a decision is made in such a way that, if the coefficients d, e and f meet the condition d+e+f<1, then the RGB input values of the computation target point P in are included in the range of the plot range of the scanned RGB values; and if the coefficients d, e and f fails to meet the condition d+e+f<1, then the RGB input values are included in the range of the plot range. In this inclusion decision processing, the search loop is repeated until the aforementioned condition is met.

Upon completion of the aforementioned inclusion decision processing, the system goes back to the Step A5 of the main routine. It then goes to the Step A6 where the image processing section 76 checks whether or not the RGB input values of the computation target point P in is located in the range of the scanned RGB values. For this check, the color gamut outside/inside decision processing is carried out by the image processing section 76. In the color gamut outside/inside decision processing, a decision to made to determine if the RGB input values of the computation target point P in is located inside or outside the color gamut, from the coefficients a, b and c gained from the intersection decision processing. If the a+b+c<0 as a decision condition is met, the controller 75 determines that the computation target point P in is located inside the color gamut. If the a+b+c<0 is not met, the controller 75 determines that the computation target point P in is located outside the color gamut.

In response to the result of the color gamut outside/inside decision processing, if the RGB input values of the computation target point P in is located within the scanned RGB values, the system goes to the Step A7. To execute the interpolation processing mode, the controller 75 applies the four lattice point search processing. In this four lattice point search processing, search is made to find out the four lattice points, out of the scanned RGB values, where the RGB input values in the color gamut are included.

After that, the system proceeds to Step A8 and the controller 75 executes the interpolation processing mode. In the interpolation processing mode, the scanned RGB values and RGB input values are expanded in the color 3D coordinate system for creating the 3D-LUT, and extracts the RGB input values of the four apexes enclosing the RGB input values of the computation target point P in, from the scanned RGB values. Based on the offset distance among these four apexes and the Lab values in the lightness/chromaticity coordinate system of the four apexes, processing is applied to obtain the color image signal of the Lab signal processing system with respect to the color image signal of the RGB signal processing system.

In this case, the controller 75 calculates the Lab values of the lightness/chromaticity coordinate system corresponding to the RGB input values of the computation target point P in. For example, the controller 75 performs processing of the interpolation computation to determine the Lab output values. In this processing of the interpolation computation, the Lab output value Q out_{Lab} is calculated from the coefficients d, e and f by the aforementioned inclusion decision processing and the Lab values—Q4_{Lab}, Q5_{Lab}, Q6_{Lab} and Q7_{Lab}—in the four apexes P4, P5, P6 and P7 of the triangular pyramid, according to the following Eq. (6) (interpolation method):

$$Q {out}_{Lab} = d \times ( {Q4}_{Lab} - {Q7}_{Lab} ) + e \times ( {Q5}_{Lab} - {Q7}_{Lab} ) + f \times ( {Q6}_{Lab} - {Q7}_{Lab} ) + {Q7}_{Lab} \qquad ( 6 )$$

After that, the system proceeds to Step A10.

In the aforementioned Step A6, when the RGB input values of the computation target point P in has been determined to be located outside the range of the scanned RGB values, the system goes to Step A9 to perform the extrapolation processing mode. In the extrapolation processing mode, the computation reference point P center is extracted out of the scanned RGB values expanded in the color 3D coordinate system, and the computation reference point P center is fixed in position. A straight line is used to connect between the computation reference point P center and computation target point P in. Then the RGB input values of the three apexes enclosing the RGB input values of the computation target point P in is extracted from the scanned RGB values. Based on the offset distance among these four apexes and the color image signal in the YMCK signal processing system, processing is applied to obtain the color image signal of the YMCK signal processing system with respect to the color image signal of the RGB signal processing system.

In this case, the controller 75 performs processing of the interpolation computation to determine the Lab values. In this processing of the interpolation computation, the Lab output value Q out_{Lab} with respect to the RGB input values of the computation target point P in is calculated from:
coefficients a, b and c obtained from the aforementioned intersection decision processing;
Lab values Q center_{Lab} in the computation reference point P center; and
Lab value Q1_{Lab}, Q2_{Lab} and Q3_{Lab} in the apexes P1, P2 and P3 of the triangle, according to the following Eq. (7) (extrapolation method):

$$Q {out}_{Lab} = a \times ( {Q1}_{Lab} - Q {center}_{Lab} ) + b \times ( {Q2}_{Lab} - Q {center}_{Lab} ) + c \times ( {Q3}_{Lab} - Q {center}_{Lab} ) + Q {center}_{Lab} \qquad ( 7 )$$

The system then goes to Step A10, and the Lab output values are checked to determine if interpolation computation processing of all lattice points has been completed or not. If the interpolation computation processing of all lattice points has been completed, the processing of creating the 3D-LUT terminates. If the interpolation computation processing of all lattice points has not been completed, the system goes back to the Step A3 to repeat the aforementioned processing loop. This procedure allows the RGB→Lab 3D-LUT to be created. The RGB→Lab 3D-LUT having been created here is written into the mask ROM using the ROM writer 77. For example, the controller 75 outputs the ROM write signal S4 to the ROM writer 77. In response to the ROM write signal S4 and ROM data D out, the ROM writer 77 writes the RGB→Lab 3D-LUT into the mask ROM. The RGB→YMCK 3D-LUT can be created by obtaining the YMCK output values corresponding to the Lab input values, based on the RGB→Lab 3D-LUT.

According to the image processing apparatus and image processing method as the first embodiment of the present invention, when the RGB→Lab 3D-LUT is to be created, the image processing section 76 checks if the RGB input values of the computation target point P in is located within the range of scanned RGB values. Based on the result of the check obtained from the image processing section 76, the controller 75 controls creation of the 3D-LUT. Based on that, if the RGB input values of the computation target point P in checked by the image processing section 76 are located within the range of scanned RGB values, the controller 75 executes interpolation processing mode. If the RGB input values of the computation target point P in are located outside the range of scanned RGB values, the controller 75 executes extrapolation processing mode.

If the RGB input values of the computation target point P in is located outside the range of the RGB input values, it is possible to find the color image signal of the YMCK signal processing system with respect to the color image signal of the RGB signal processing system, based on the RGB input values of the computation reference point P center extracted from the scanned RGB values expanded in the color 3D coordinate system and fixed in position. This procedure makes it possible to standardize the origin of the radiation of the extrapolated vectors i, ii, iii and iv, and ensures compatibility between the improvement of color difference in the color image signal of the YMCK signal processing system and the smoothness of color conversion in the 3D-LUT, as compared to the prior art technique.

FIGS. 12(a) and (b) are drawings showing the examples of evaluation and color conversion patterns when a color is converted from green (G) to magenta (M) in the present invention.

The example of color conversion patterns when a color is converted from green (G) to magenta (M) shown in FIG. 12(a) is a graphic representation of the Lad output value of the example of the color conversion pattern shown in FIG. 12(b). The vertical axis indicates the lightness L* and chromaticity a* or b* showing the Lab output values. The scale denotes evaluation values given in ±200. The horizontal axis represents the evaluation pixel. The evaluation pixel is given in relative values 0 through 100. The solid line denotes lightness L*, while the dashed line indicates the chromaticity a* and the one-dot chain line represents the chromaticity b*.

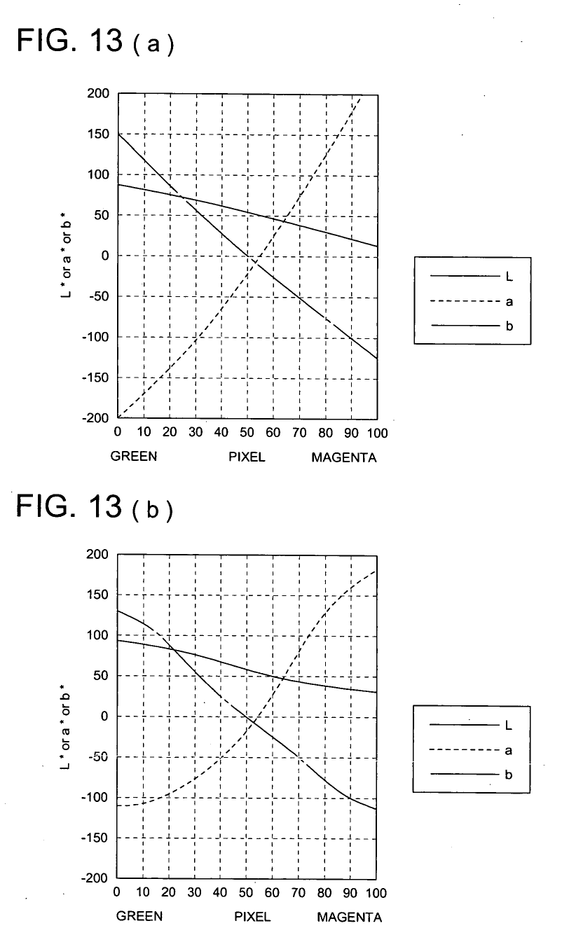

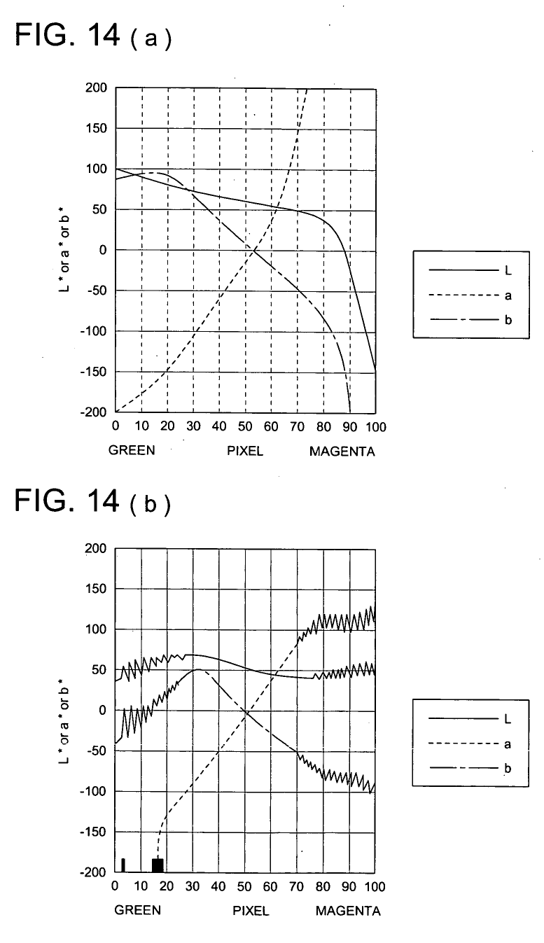

The example of the color conversion pattern given in FIG. 12(b) represents a pattern when the gradation RGB data that changes from the green (R, G, B=0, 255, 0) to magenta (255, 0, 255) is converted into the Lab output values (shown in monochrome in the drawing). The relative value 0 of the evaluation pixel corresponds to the G-color and the evaluation pixel 100 corresponds to M-color. This applies to the cases shown in FIGS. 13(a) and (b) and FIGS. 14(a) and (b).

The information on lightness L* and chromaticity a* or b* shown in FIG. 12(a) is obtained through correspondence with the scanned RGB values of three apexes enclosing the RGB input values of the computation target point P in and the scanned RGB values of the computation reference point P center by:
extracting the computation reference point P center out of the scanner signal represented in the color 3D coordinate system in the extrapolation processing mode;
fixing the computation reference point P center in position; and
connecting between the computation reference point P center and computation target point P in, using a straight line.

Any information on the lightness L* and chromaticity a* or b* is linear. This linearity determines the quality of the color conversion from green (G) to Magenta (M) colors. The color conversion characteristics from G to M colors in the present invention provide the color conversion efficiency. According to the color conversion from green (G) to Magenta (M) colors in the present invention the color conversion efficiency comparable to that of the primary matrix processing as given below can be obtained:

FIG. 13(a) is a drawing representing an example (Lab) of evaluating the color conversion from G to M colors as a first comparative example with respect to the example of evaluating the color conversion from G to M in the present invention. The vertical axis of FIG. 13(a) represents information on the lightness L* and chromaticity a* or b*. The solid line denotes lightness L* calculated by primary matrix processing, while the dotted line indicates the chromaticity a* and the one-dot chain line represents the chromaticity b*. The information on the lightness L* and chromaticity a* or b* has almost the same configuration as that of the color conversion characteristics from G to M colors according to the present invention.

FIG. 13(b) is a drawing representing an example (Lab) of evaluating the color conversion from G to M colors as a second comparative example with respect to the example of evaluating the color conversion from G to M in the present invention. The vertical axis of FIG. 13(b) represents information on the lightness L* and chromaticity a* or b*, showing the Lab output values calculated by the secondary matrix processing. The solid line denotes lightness L* calculated by the secondary matrix processing, while the dotted line indicates the chromaticity a* and the one-dot chain line represents the chromaticity b*. The information on the lightness L* has almost the same configuration as that of the color conversion characteristics from G to M colors according to the present invention, but the information on chromaticity a* or b* exhibits a poor linearity.

FIG. 14(a) is a drawing representing an example (Lab) of evaluating the color conversion from G to M colors as a third comparative example with respect to the example of evaluating the color conversion from G to M in the present invention. The vertical axis of FIG. 14(a) represents information on the lightness L* and chromaticity a* or b*, showing the Lab output values calculated by the tertiary matrix processing.

The solid line denotes lightness L* calculated by calculated by the tertiary matrix processing, while the dotted line indicates the chromaticity a* and the one-dot chain line represents the chromaticity b*. As compared to the color conversion characteristics according to the present invention, the information on the lightness L* and chromaticity a* or b* including that of the curved portion exhibits a poor linearity.

FIG. 14(b) is a drawing representing an example (Lab) of evaluating the color conversion from G to M colors as a fourth comparative example with respect to the example of evaluating the color conversion from G to M in the present invention. The vertical axis of FIG. 14(b) represents information on the lightness L* and chromaticity a* or b*, showing the Lab output values obtained by calculation processing according to prior art technique.

The solid line denotes lightness L* calculated by calculated by the prior art technique, while the dotted line indicates the chromaticity a* and the one-dot chain line represents the chromaticity b*. As compared to the color conversion characteristics according to the present invention, the information on the lightness L* and chromaticity a* or b* including that of the curved portion exhibits completely different characteristics.

From the above description, it can be seen that, as compared with the prior art technique shown in FIG. 14(b), the color conversion characteristics from G to M colors of the present invention shown in FIG. 12(a) are superior in linearity. Further, when compared with the matrix type, it can be seen that the primary matrix shown in FIG. 13(a) and linearity can be obtained.

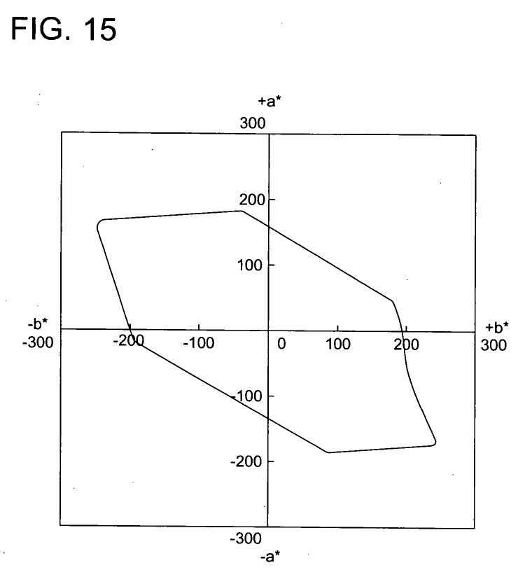

FIG. 15 is a drawing showing an example of evaluating the smoothness in color conversion from (G) to (M) in the present invention. In the example of evaluating the smoothness, connection of the lattice points in the 3D-LUT is evaluated. In this example, the colors of the RGB input values of the 3D-LUT are converted into those of the Lab output values.

The vertical axis of FIG. 15 represents the information on the chromaticity a*, showing the smoothness in color conversion from (G) to (M). The horizontal axis represents the information on the chromaticity b*. Any evaluation value is expressed in terms of 0±300. The solid line indicates an evaluation form showing the degree of smoothness. When the evaluation form is such that a straight line is closed for connection and the closed area is larger, it is evaluated as “acceptable”. Conversely, if irregularities are found in the evaluation form, the form is not closed, and the closed area is smaller, it is evaluated as “unacceptable”.

The example of evaluating the smoothness shown in FIG. 15 is obtained through correspondence with the scanned RGB values of three apexes enclosing the RGB input values of the computation target point P in and the scanned RGB values of the computation reference point P center by:
extracting the computation reference point P center out of the scanner signal represented in the color 3D coordinate system in the extrapolation processing mode;
fixing the computation reference point P center in position; and
connecting between the computation reference point P center and computation target point P in, using a straight line.

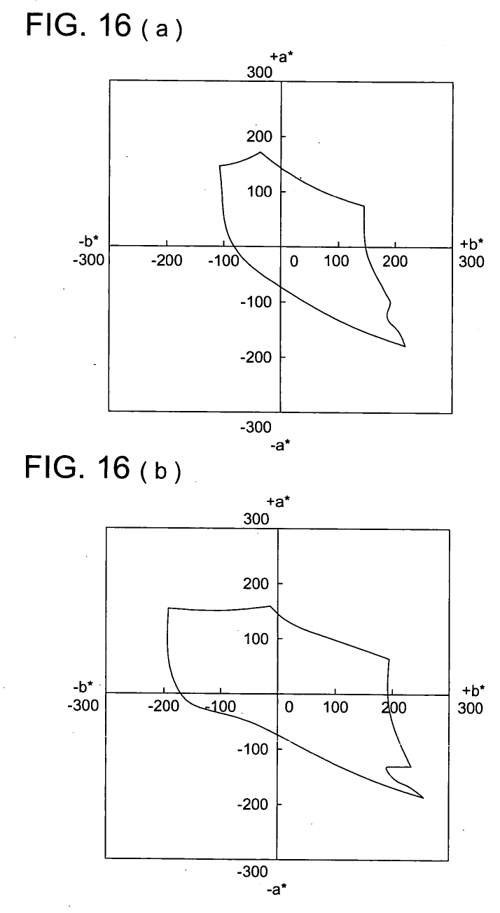

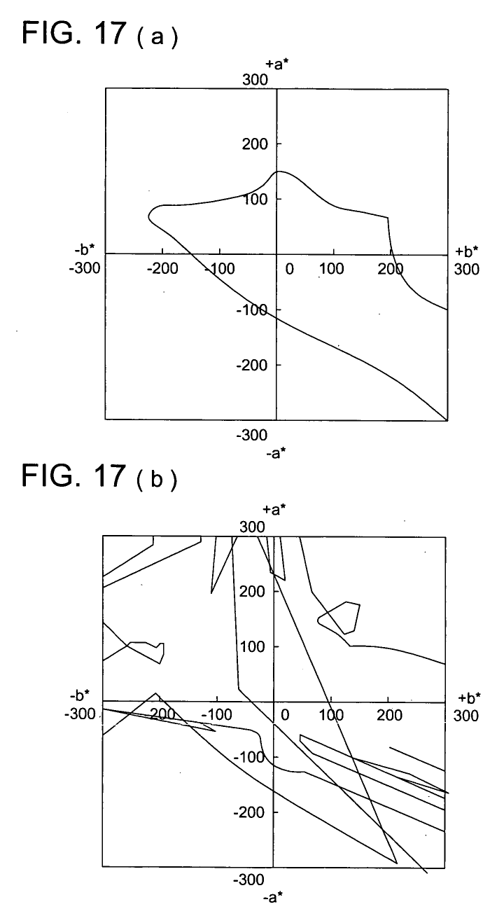

Due to the improvement of extrapolation method and adoption of the Lab 3D color coordinate system for the 3D coordinate system in the extrapolation processing mode, the evaluation form is such that a straight line is closed for connection and the closed area is increased, in the example of evaluating the smoothness in the present invention. This signifies a substantial improvement and, excellent linear and smooth configuration, as compared with matrix processing technique shown in FIGS. 16 and 17 and the prior art method.

FIGS. 16(a) and (b) are diagrams showing comparative examples (Nos. 1 and 2) of evaluating the smoothness in color conversion from G to M. The vertical axis of FIG. 16(a) represents chromaticity a* showing the smoothness in color conversion from G to M in the primary matrix processing. The horizontal axis shows the information on chromaticity b*. Any evaluation value is expressed in terms of 0±300. The solid line indicates an evaluation form showing the degree of smoothness in the primary matrix processing. In the example of evaluating the smoothness shown in FIG. 16(a), a sharp area appears on the evaluation form even though the evaluation form undergoes a linear change. If the degree of smoothness is low, reproduction of the image gradation will be adversely affected.

The vertical axis of FIG. 16(b) represents chromaticity a* showing the smoothness in color conversion from G to M in the secondary matrix processing. The horizontal axis shows the information on chromaticity b*. Any evaluation value is expressed in terms of 0±300. The solid line indicates an evaluation form showing the degree of smoothness in the secondary matrix processing. In the example of evaluating the smoothness shown in FIG. 16(b), a sharp area appears on the evaluation form even though the evaluation form undergoes a linear change. If the degree of smoothness is low, reproduction of the image gradation will be adversely affected. The degree of the smoothness is deteriorated because the order is increased by one degree, when compared to that in primary matrix processing.

FIGS. 17(a) and (b) show comparative examples (Nos. 3 and 4) of evaluating the smoothness in color conversion from green (G) to magenta (M). The vertical axis of FIG. 17(a) represents chromaticity a* showing the smoothness in color conversion from G to M in the tertiary matrix processing. The horizontal axis shows the information on chromaticity b*. Any evaluation value is expressed in terms of 0±300. The solid line indicates an evaluation form showing the degree of smoothness in the tertiary matrix processing.

In the example of evaluating the smoothness shown in FIG. 17(a), the evaluation form is not closed even though the evaluation form exhibits a linear change. If it is not closed, reproduction of the image gradation will be adversely affected. The degree of the smoothness is deteriorated because the order is increased by two degrees, when compared to that in primary matrix processing.

The vertical axis of FIG. 17(b) represents chromaticity a* showing the smoothness in color conversion from G to M in the prior art technique. The horizontal axis shows the information on chromaticity b*. Any evaluation value is expressed in terms of 0±300. The solid line represents an evaluation form showing the degree of smoothness in the prior art method. In the example of evaluating the smoothness shown in FIG. 17(b), the evaluation form exhibits a random change and is not closed, thereby deteriorating the reproduction of the image gradation.

From the above description, it can be seen that, as compared with the prior art technique shown in FIG. 17(b), the color conversion characteristics from G to M colors of the present invention shown in FIG. 15 are improved in smoothness. Further, when compared with the matrix type, it can be seen that the degree of smoothness is reduced as the order is raised from primary to secondary, then to tertiary, as shown in FIGS. 16(a) and (b) and FIG. 17(a); whereas this does not occur at all in the case of interpolation computation processing. Thus, excellent reproducibility of image gradation can be maintained.

Table 1 shows the average color difference in interpolation computation processing and that in the comparative example. In this example, a 3D-LUT has been created for the 5³ patch originals 80. The scanned RGB values are subjected to XYZ conversion by the 3D-LUT, and are further subjected to Lab conversion. The table shows the relationship of the average color difference between the result of this processing and the Lab value the color of which has been measured.

TABLE 1

| | | | | Interpolation type | |
|---|---|---|---|---|---|
| | Matrix type | | | Prior art | Present |
| | Primary | Secondary | Tertiary | method | method |
| Average | 6.5 | 4.7 | 4.3 | 0.38 | 0.34 |
| color | | | | | |
| difference | | | | | |

In Table 1, the average color difference of the primary matrix is 6.5, that of the secondary matrix is 4.7 and that of the tertiary matrix is 4.3. The average color difference is 0.38 in the prior art interpolation type. By contrast, in the interpolation method according to the present invention, the average color difference is 0.34. As described above, as the matrix order is raised, the average color difference is reduced. Thus, it can be seen that the average color difference in the present invention exhibits a substantial improvement over the matrix type, and is almost equivalent to that of the prior art method.

### Embodiment 2

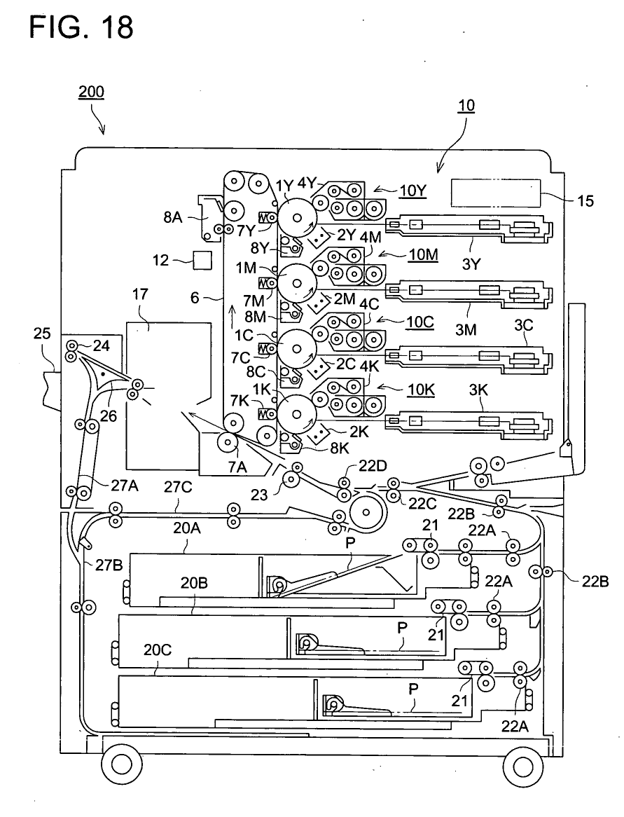

FIG. 18 is a conceptual diagram showing an example of the cross sectional view of a color printer 200 as a second embodiment in the present invention.

The color printer 200 shown in FIG. 18 provides an example of an image forming apparatus. Based on the color image signal of the signal processing system of the yellow (Y), magenta (M), cyan (C) and black (K) obtained by color conversion of the color image signal of the red, green and blue (RGB) signal processing system, the color printer 200 allows a color image to be formed on a desired sheet of paper P. This image forming apparatus reproduces gradation using a 3D color information conversion table (hereinafter referred to as “3D-LUT”) of eight or more bits. It is preferably applicable to a color facsimile machine, color copying machine, and their composite machine (copier) in addition to the printer 200.

The printer 200 is a tandem color image forming apparatus and comprises an image forming section 10. The image forming section 10 comprises a plurality of image forming units 10Y, 10M, 10C and 10K having an image forming body for each color; an endless intermediate transfer belt 6; a sheet feed/sheet conveyance section including an automatic sheet re-feed mechanism (ADU mechanism); and a fixing device for fixing a toner image.

In this example, the image forming unit 10Y for forming a yellow (hereinafter referred to as “Y color”) image consists of a photoconductor drum 1Y for forming a Y color toner image, a charging section 2Y for Y color arranged around the photoconductor drum 1Y, a laser writing unit (exposure section) 3Y, a development apparatus 4Y, and an image formation cleaning section 8Y. The image forming unit 10Y transfers the Y color toner image formed on the photoconductor drum 1Y, onto the intermediate transfer belt 6.

The image forming unit 10M for forming a M color image comprises a photoconductor drum 1M for forming a M color toner image, a M color charging device 2M, a laser writing unit 3M, a development apparatus 4M and an image formation cleaning section 8M. The image forming unit 10M transfers the M color toner image formed on the photoconductor drum 1M, onto the intermediate transfer belt 6.

The image forming unit 10C for forming a C color image comprises a photoconductor drum 1C or forming a C color toner a development apparatus 4C and an image formation cleaning section 8C. The image forming unit 10C transfers the C color toner image formed on the photoconductor drum 1C, onto the intermediate transfer belt 6.

The image forming unit 10K for forming a BK color image comprises a photoconductor drum 1K or forming a BK color toner image, a BK color charging device 2K, a laser writing unit 3K, a development apparatus 4K and an image formation cleaning section 8K. The image forming unit 10K transfers the BK color toner image formed on the photoconductor drum 1K, onto the intermediate transfer belt 6.

The charging section 2Y and laser writing unit 3Y, the charging section 2M and laser writing unit 3M, the charging section 2C and laser writing unit 3C, and the charging section 2K and laser writing unit 3K form latent image forming sections, respectively. Development by the development apparatuses 4Y, 4M, 4C and 4K is carried out by the reverse development wherein alternating current voltage is superimposed on the direct current voltage of the same polarity (negative in the present embodiment) as that of the toner to be used. The intermediate transfer belt 6 tracks a plurality of rollers and is supported rotatably so as to transfer each of toner images of Y, M, C and BK colors formed on the photoconductor drums 1Y, 1M, 1C and 1K.

The following describes the summary of the image forming process: The color images formed by the image forming units 10Y, 10M, 10C and 10K are sequentially transferred on the intermediate transfer belt 6 by the primary transfer rollers 7Y, 7M, 7C and 7K to which the primary transfer bias (not illustrated) of the polarity (positive in the present embodiment) opposite to that of the toner to be used is applied (primary transfer), whereby a composite color image (color image: color toner image) is formed. The color image is transferred to the paper P from the intermediate transfer belt 6.

Sheet feed cassettes 20A, 20B and 20C are provided below the image forming unit 10K. The sheet P stored in the sheet feed cassette 20A is fed by a feedout roller 21 and a sheet feed roller 22A, and is conveyed to the secondary transfer roller 7A through the conveyance rollers 22B, 22C, and 22D, resist roller 23 and others. Then color images are collectively transferred onto one side (obverse side) of the paper A (secondary transfer).

The paper P with the color image transferred thereon is subjected to fixing process by a fixing device 17. Being sandwiched between the ejection rollers 24, the paper P is placed on an ejection tray 25 out of the machine. The toner remaining on the peripheral surface of the photoconductor drums 1Y, 1M, 1C and 1K after transfer is removed by the image formation body cleaning sections 8Y, 8M, 8C and 8K. Then the system enters the next image formation cycle.

In the double-sided image formation mode, sheets of the paper P, with an image formed on one side (obverse side), having been ejected from the fixing device 17, are branched off from the sheet ejection path by the branching section 26, and are reversed by the reversing conveyance path 27B as an automatic sheet re-feed mechanism (ADU mechanism) through the circulating paper feed path 27A, located below, constituting the sheet feed/conveyance section. Then these sheets of paper P are put together by the sheet feed roller 22D after passing through the re-feed/conveyance section 27C.

After passing through the resist roller 23, the paper P having been reversed and conveyed is again fed to the secondary transfer roller 7A and the color images (color toner images) are collectively transferred on the other side (reverse side) of the paper P. The paper P with the color images transferred thereon is subjected to the process of fixing by the fixing device 17. Being sandwiched between the ejection rollers 24, the paper P is placed on an ejection tray 25 out of the machine.

After the color image has been transferred onto the paper P by the secondary transfer roller 7A, the remaining toner is removed by the intermediate transfer belt cleaning section 8A from the intermediate transfer belt 6 having applied curvature-separation of the paper P.

When an image is formed, 52.3 through 63.9 kg/m² (1000 sheets) of thin paper, 64.0 through 81.4 kg/m² (1000 sheets) of plain paper, 83.0 through 130.0 kg/m² (1000 sheets) of heavy paper or 150.0 kg m² (1000 sheets) of extra-heavy paper are used as paper P. The paper P used has a thickness of 0.05 through 0.15 mm.

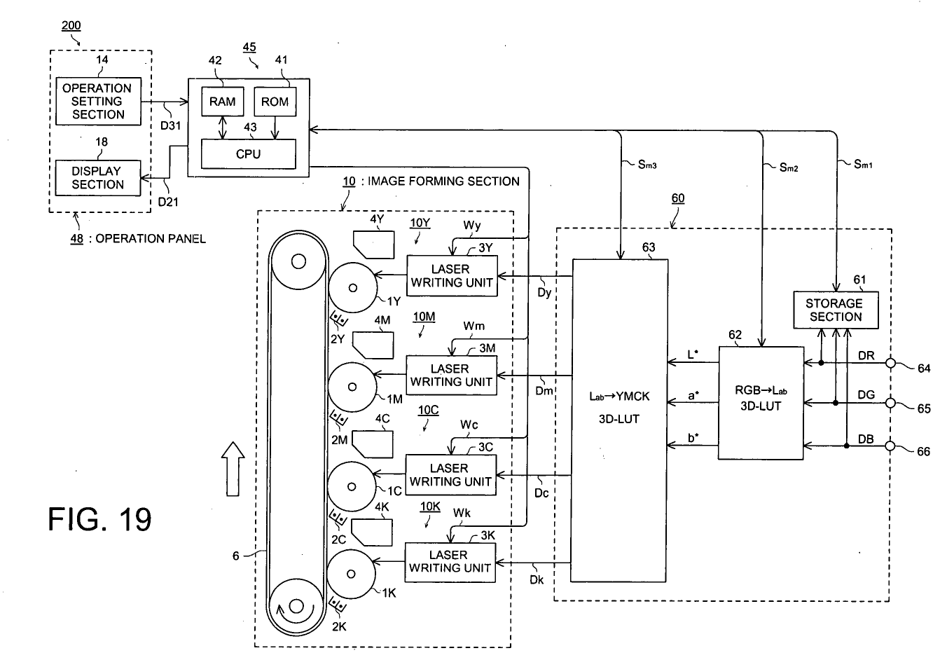

FIG. 19 is a block diagram showing an example of the internal configuration of a printer 200. The printer 200 shown in FIG. 19 allows the gradation to be reproduced by the gradation reproduction table of 8 or more bits (formation of color image by superimposition of colors). The image forming unit 10 comprises a controller 45, an operation panel 48, a color conversion section 60, an external connection terminals 64 through 66.

The controller 45 is equipped with ROM 41, RAM 42 and CPU 43. The ROM 41 stores the system program data for overall control of the printer. The RAM 42 is used as a work memory and is used, for example, for temporary storage of the control command, etc. When power is turned on, the CPU 43 starts the system by reading the system program data from the ROM 41, and provides overall control of the printer based on the operation data D31.

The controller 45 is connected with the operation panel 48 based on GUI (Graphical User Interface) system. This operation panel 48 is equipped with an operation setting section 14 consisting of a touch panel, and a display section 18 consisting of a liquid crystal display panel. The operation setting section 14 is operated to set the image forming conditions such as paper size and image density. The image forming conditions and paper feed cassette selection information are outputted to the controller 45 in the form of the operation data D31. The controller 45 is connected with the display section 18 in addition to the operation setting section 14. For example, information on the number of sheets to be printed and density is displayed according to the display data D21.

In this example, based on the operation data D31 gained from the operation setting section 14, the controller 45 controls the image forming unit 10, display section 18 and color conversion section 60. The color conversion section 60 is connected with the external connection terminals 63 through 65. Color image data DR, DG and DB of the 8-bit RGB signal processing system is inputted, for example, from external peripheral equipment. This color image data DR, DG and DB is subjected to color conversion to become a color image information Dy, Dm, Dc and Dk of the YMCK signal processing system. Any one of the 3D-LUTs created according to the image processing apparatus 100 of the present invention and/or the image processing method thereof is applied to the color conversion section 60.

In this example, the color conversion section 60 consists of a storage apparatus 61, RGB→Lab 3D-LUT 62 and Lab→YMCK 3D-LUT 63. When the 8-bit red (R), green (G) and blue (B) are to be reproduced, the RGB→Lab 3D-LUT 62 and Lab→YMCK 3D-LUT 63 allows each of the Lab output values corresponding to the RGB to be expressed in terms of the input gradation values from 0 through 255. The external peripheral equipment includes a scanner, PC, and digital camera.

The external connection terminals 64 through 66 is connected with the storage apparatus 61 and RGB→Lab 3D-LUT 62. Color image data DR, DG and DB is inputted and is temporarily stored in the storage apparatus 61, based on the memory control signal Sm1. The memory control signal Sm1 is outputted from the controller 45 to the storage apparatus 61. In the RGB→Lab 3D-LUT 62, the color image data DR, DG and DB read from the storage apparatus 61 is converted into the information on the lightness L* and chromaticity a* or b* of the Lab color coordinate system, based on the memory control signal Sm2. The memory control signal Sm2 is outputted from the controller 45 to the RGB→Lab 3D-LUT 62. What is used in the RGB→Lab 3D-LUT 62 is the one created by the image processing apparatus 100 of the present invention and written into the ROM (Read Only Memory) that is built into a semiconductor integrated circuit (IC).

The RGB→Lab 3D-LUT 62 is connected with the Lab→YMCK 3D-LUT 63, and information on the lightness L* and chromaticity a* or b* of the Lab color coordinate system is subjected to color conversion into the color image information Dy, Dm, Dc and Dk of the YMCK signal processing system, based on the memory control signal Sm3. The memory control signal Sm3 is outputted from the controller 45 to the Lab→YMCK 3D-LUT 63. What is used in the RGB→Lab 3D-LUT 62 is the one created by the image processing apparatus 100 of the present invention and written into the ROM (Read Only Memory) that is built into a semiconductor integrated circuit (IC).

The Lab→YMCK 3D-LUT 63 is connected with the image forming unit 10. A color image is formed, based on the color image information Dy, Dm, Dc and Dk subjected to color conversion by the color conversion section 60. The image forming unit 10 consists of the intermediate transfer belt 6 shown in FIG. 18 and the image forming units 10Y, 10M, 10C and 10K. The image forming units 10Y, 10M, 10C and 10K are equipped with laser image writing units 3Y, 3M, 3C and 3K.

In this example, the color image information Dy read out from the aforementioned Lab→YMCK 3D-LUT 63 is outputted to the Y-color laser writing unit 3Y. Similarly, the color image information Dm is outputted to the M-color laser writing unit 3M, the color image information Dc is outputted to the C-color laser writing unit 3C, and the color image information Dk is outputted to the BK-color laser writing unit 3K.

The controller 45 is connected to each of the laser writing units 3Y, 3M, 3C and 3K, and controls the color image information Dy, Dm, Dc and Dk in these units 3Y, 3M, 3C and 3K. For example, in response to the interrupt control signal Wy of the controller 45, laser writing unit 3Y operates to write the Y-color image information Dy into the photoconductor drum 1Y. The electrostatic latent image written into the photoconductor drum 1Y is developed by the Y-color toner member in the development apparatus 4Y shown in FIG. 1, and is transferred to the intermediate transfer belt 6.

In response to the interrupt control signal Wm of the controller 45, the laser writing unit 3M operates to write the M-color image information Dm into the photoconductor drum 1M. The electrostatic latent image written into the photoconductor drum 1M is developed by the M-color toner member in the development apparatus 4M shown in FIG. 1, and is transferred to the intermediate transfer belt 6.

In response to the interrupt control signal Wc of the controller 45, the laser writing unit 3C operates to write the C-color image information Dc- into the photoconductor drum 1C. The electrostatic latent image written into the photoconductor drum 1C is developed by the C-color toner member in the development apparatus 4M shown in FIG. 1, and is transferred to the intermediate transfer belt 6.

In response to the interrupt control signal Wk of the controller 45, the laser writing unit 3K operates to write the BK-color image information Dk into the photoconductor drum 1K. The electrostatic latent image written into the photoconductor drum 1K is developed by the BK-color toner member in the development apparatus 4K shown in FIG. 1, and is transferred to the intermediate transfer belt 6.

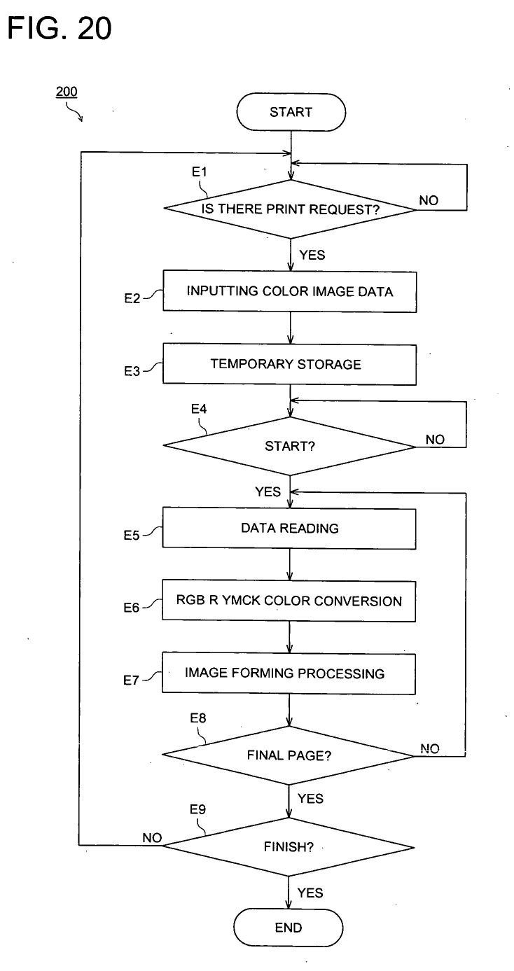

The following describes the operation example of the color printer 200. FIG. 20 is a flowchart representing the operation of the printer 200.

In this embodiment, when a color image is formed based on the color image information Dy, Dm, Dc and Dk of the YMCK signal processing system obtained by color conversion of the color image data DR, DG and DB of the RGB signal processing system, it is assumed that the RGB→Lab 3D-LUT 62 and Lab→YMCK 3D-LUT 63 created by the image processing apparatus 100 of the present invention and the image processing method thereof are applied to the color conversion section 60.

Using the above as an operation condition, the controller 45 in Step E1 of the flowchart given in FIG. 20 waits for print request. The print request is notified from external peripheral equipment. This print request is stored in the storage apparatus 61. This is received by the CPU 43 in the controller 45 and a decision is made to determine if there is any print request or not.

If there is a print request, the system goes to Step E2, and color image data DR, DG and DB is stored in the storage apparatus 61 on the temporary basis. Subsequently, the system waits for the start instruction in the Step E4. The start instruction will be notified from the external peripheral equipment, similarly to the case of print request. This start instruction is stored in the storage apparatus 61 and is received by the CPU 43 inside the controller 45, whereby the start instruction is evaluated. Without being restricted to the aforementioned arrangement, it is also possible to make such arrangements as to detect the depressing of the start button provided on the operation setting section 14 of the color printer 200 and to start printing operation in response to this stat instruction.

Proceeding to the Step E5, the controller 45 outputs the memory control signal Sm1 to the storage apparatus 61. For example, it reads the color image data DR, DG and DB for one page from the storage apparatus 61 and outputs it to the RGB→Lab 3D-LUT 62.

Subsequently, the RGB→YMCK color conversion processing is carried out in Step E6. In this case, the RGB→Lab 3D-LUT 62 converts the color image data DR, DG and DB having been read from the storage apparatus 61, into information on the lightness L* and chromaticity a* or b* of the Lab 3D color coordinate system, based on the memory control signal Sm2. Further, based on the memory control signal Sm3, the Lab→YMCK 3D-LUT 63 executes color conversion of the information on the lightness L* and chromaticity a* or b* of the Lab 3D color coordinate system, into the color image information Dy, Dm, Dc and Dk of the YMCK signal processing system.

In Step E7, the image forming unit 10 applies the processing of color image formation. In this case, the image forming unit 10Y allows an electrostatic latent image to be written into the photoconductor drum 1Y by the Y-color laser writing unit 3Y, based on the image data Dy of the Y color subsequent to color conversion. The electrostatic latent image of the photoconductor drum 1Y is developed by the development apparatus 4Y and is changed into a Y-color toner image. The image forming unit 10M allows an electrostatic latent image to be written into the photoconductor drum 1M by the M color laser writing unit 3M, based on the image data Dm of the M color. The electrostatic latent image of the photoconductor drum 1M is developed by the development apparatus 4M and is changed into a M-color toner image.

The image forming unit 10C allows an electrostatic latent image to be written into the photoconductor drum 1C by the C-color laser writing unit 3C, based on the image data Dy of the C color. The electrostatic latent image of the photoconductor drum 1C is developed by the development apparatus 4C and is changed into a C-color toner image. The image forming unit 10K allows an electrostatic latent image to be written into the photoconductor drum 1K by the BK-color laser writing unit 3K, based on the image data Dk of the BK color. The electrostatic latent image of the photoconductor drum 1K is developed by the development apparatus 4K and is changed into a BK-color toner image.

The toner images of the Y, M, C and BK colors of the photoconductor drums 1Y, 1M, 1C and 1K are sequentially transferred onto the intermediate transfer belt 6 rotated by the primary transfer rollers 7Y, 7M, 7C and 7K, whereby a composite color image (color image: color toner image) is formed. The color image is transferred to paper P from the intermediate transfer belt 6.

In Step E8, a check is made to see if the final page has been printed or not. If it is not yet printed, the system goes back to the Step E5, and reads out the color image data DR, DG and DB from the storage apparatus 61. The color image data DR, DG and DB is then outputted to the RGB→Lab 3D-LUT 62. The aforementioned procedure is then repeated. If the final page has been printed, the system proceeds to Step E9, and a check is made to see if the image formation processing has terminated or not. The controller 45 checks the power off information, for example, and terminates image formation processing. If the power off information is not detected, the system goes back to Step E1 and the aforementioned procedure is repeated.

As described above, according to the color printer 200 as the second embodiment of the present invention, when a color image is to be formed based on the color image information Dy, Dm, Dc and Dk of the YMCK signal processing system obtained by color conversion of the color image data DR, DG and DB of the RGB signal processing system, the RGB→Lab 3D-LUT 62 and Lab→YMCK 3D-LUT 63 created by the image processing apparatus 100 of the present invention and the image processing method thereof are applied to the color conversion section 60.

Thus, it is possible to ensure compatibility between reduction of the average color differences in the color image information Dy, Dm, Dc and Dk of the YMCK signal processing system and smooth color conversion by the RGB→Lab 3D-LUT 62 and Lab→YMCK 3D-LUT 63, whereby a high quality color image can be formed.

### Embodiment 3

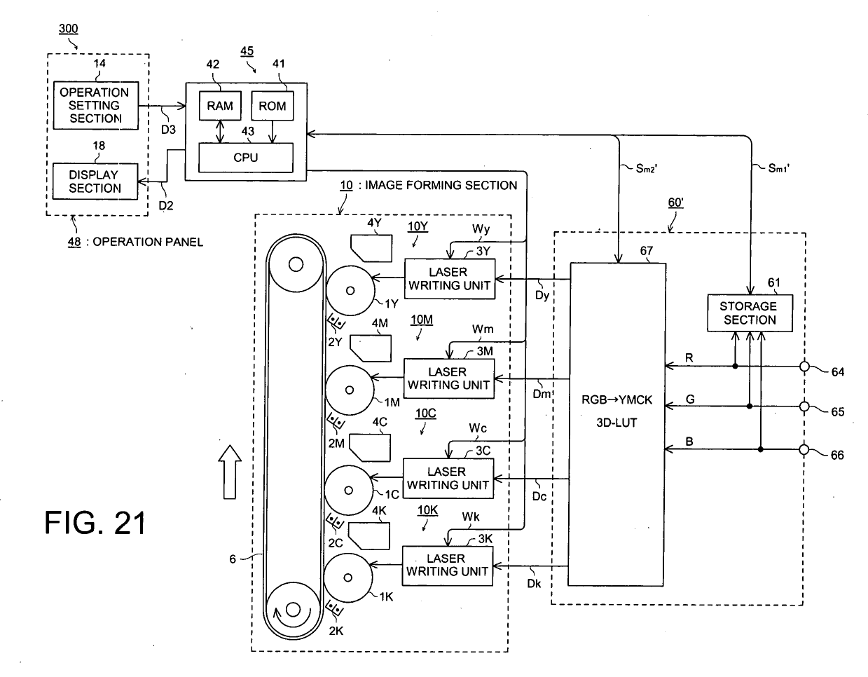

FIG. 21 is a block diagram representing an example of the configuration of a printer 300 as a third embodiment in the present invention. The printer 300 shown in FIG. 21 is another example of the image forming apparatus, reproduces gradation (formation of a color image by superimposition of colors) using a 3D color information conversion table of eight or more bits. It is equipped with an image forming unit 10, controller 45, operation panel 48, color conversion section 60′ and external connection terminals 64 through 66.

The color conversion section 60′ is equipped with a storage apparatus 61 and RGB→YMCK 3D-LUT 67. The RGB→YMCK 3D-LUT 67 is a 3D color information conversion table for converting color image data DR, DG and DB of the RGB signal processing system into color image information Dy, Dm, Dc and Dk of the YMCK signal processing system. The RGB→YMCK 3D-LUT 67 allows each of the color image information Dy, Dm, Dc and Dk of the RGB signal processing system to be expressed in terms of the input gradation value from 0 through 255, when reproducing the 8-bit red (R), green (G) and blue (B), for example.

What is used in the RGB→YMCK 3D-LUT 67 is the one created by the image processing apparatus 100 of the present invention and written into the ROM (Read Only Memory) that is built into a semiconductor integrated circuit (IC). The RGB YMCK 3D-LUT 67 uses the ROM wherein the RGB→Lab 3D-LUT 62 and Lab→YMCK 3D-LUT 63 built into one and same semiconductor chip, as described with reference to the second embodiment. The components having the same names and reference numerals have the same functions, and will not be described to avoid duplication.

The following describes the operations of the printer 300. For example, similarly to the case of the second embodiment, the color image data DR, DG and DB is stored temporarily in the storage apparatus 61, in response to the memory control signal Sm1. The memory control signal Sm1 is outputted from the controller 45 to the storage apparatus 61. In the RGB→YMCK 3D-LUT 67, the color image data DR, DG and DB having been read from the storage apparatus 61 is subjected to primary conversion into the information on lightness L* and chromaticity a* or b* of the Lab 3D color coordinate system, in response to the memory control signal Sm2′. The memory control signal Sm2′ is outputted from the 45 to the RGB→YMCK 3D-LUT 67.

In the RGB→YMCK 3D-LUT 67, the information on lightness L* and chromaticity a* or b* of the Lab 3D color coordinate system obtained from the primary conversion is subjected to secondary conversion into the color image information Dy, Dm, Dc and Dk of the YMCK signal processing system. The color image information Dy, Dm, Dc and Dk of the YMCK signal processing system gained by secondary conversion is outputted to the image forming unit 10 in response to the memory control signal Sm2′. The image forming unit 10 forms a color image according to the color image information Dy, Dm, Dc and Dk subjected to color conversion by the color conversion section 60′.

As described above, according to the color printer 300 as a third embodiment of the present invention, when forming a color image based on the color image information Dy, Dm, Dc and Dk of the YMCK signal processing system obtained by color conversion of the color image data DR, DG and DB of the RGB signal processing system, the RGB→YMCK 3D-LUT 67 created by the image processing apparatus 100 of the present invention and the image processing method thereof is applied to the color conversion section 601.

This ensures compatibility between reduction of the average color differences in the color image information Dy, Dm, Dc and Dk of the YMCK signal processing system and smooth color conversion by the RGB→YMCK 3D-LUT 67, whereby a high quality color image can be formed.

### INDUSTRIAL FIELD OF APPLICATION

The present invention is preferably applied to a color copying machine, a color printer and a composite machine thereof, wherein a color image is formed by processing of color conversion and/or color adjustment applied to the image information of the RGB signal processing system in conformity to the 3D-LUT, for conversion into the image information of the YMCK signal processing system.

Further, this 3D-LUT may be created and applied prior to shipment of the product, or may be created by reading of the patch original, as required, when used by the user.

1. An image processing apparatus for creating a 3D color information conversion table for converting a color image signal of one signal processing system into a color image signal of the other signal processing system, based on: color measurement signals obtained by color measuring of a reference color original where N-fold N² pieces of reference color images are arranged in such a way that respective intensities of red, green and blue (RGB) of the reference color images are increased in order; and image reading signals obtained by reading the reference color originals through light exposure scanning; the image processing apparatus comprising:
an interpolation processing unit for obtaining output values of the color measurement signals corresponding to RGB input values on four apexes enclosing a RGB input value of a computation target point, when the image reading signals are expanded on a color 3D coordinate system to express the RGB input value for creating the 3D color information conversion table;
an extrapolation processing unit for extracting a computation reference point out of the image reading signals expressed on the color 3D coordinate system, fixing the computation reference point, connecting between the computation reference point and the computation target point, and thereby obtaining the output values of the color measurement signal corresponding to RGB input values of three apexes enclosing the RGB input value of the computation target point and to a RGB input value of the computation reference point;
an image processing unit for detecting whether the RGB input value of the computation target point is located within the range of the image reading signals; and
a control unit for controlling creation of the 3D color information conversion table based on a detecting result by the image processing unit;
wherein the control unit allows the interpolation processing unit to execute interpolation processing, when the RGB input value of the computation target point detected by the image processing unit is located within the range of the image reading signals, and allows the extrapolation processing unit to execute extrapolation processing, when the RGB input value of the computation target point is located outside the range the image reading signals.

2. The image processing apparatus of claim 1, wherein the control unit computes values of lightness and chromaticity in a lightness/chromaticity coordinate system (La*b* values) corresponding to the RGB input values.

3. The image processing apparatus of claim 1, wherein the control unit selects a gradation number equal in terms of each RGB axis of the color 3D coordinate system, the gradation number being obtained from the reference color original where N-fold N² pieces of reference color images, and the control unit sets the RGB input value of the computation reference point.

4. An image processing method for creating a 3D color information conversion table for converting a color image signal of one signal processing system into a color image signal of the other signal processing system, based on: color measurement signals obtained by color measuring of a reference color original where N-fold N² pieces of reference color images are arranged in such a way that respective intensities of red, green and blue (RGB) of the reference color images are increased in order; and image reading signals obtained by reading the reference color originals through light exposure scanning; the image processing method comprising:
an interpolation processing mode for obtaining output values of the color measurement signals corresponding to RGB input values on four apexes enclosing a RGB input value of a computation target point, when the image reading signals are expanded on the color 3D coordinate system to express the RGB input value for creating the 3D color information conversion table; and
an extrapolation processing mode for extracting a computation reference point out of the image reading signals expressed on the color 3D coordinate system, fixing the computation reference point, connecting between the computation reference point and the computation target point, and thereby obtaining the output values of the color measurement signal corresponding to RGB input values of three apexes enclosing the RGB input value of the computation reference point; wherein the image processing method comprising the steps of:
detecting whether the RGB input value of the computation target point is located within the range of the image reading signals;
executing interpolation processing when the RGB input value of the computation target point is located within the range of the image reading signals, and executing extrapolation processing when the RGB input value of the computation target point is located outside the range the image reading signals.

5. The image processing method of claim 4, further comprising the step of computing values of lightness and chromaticity in a lightness/chromaticity coordinate system (La*b* values) corresponding to the RGB input values.

6. The image processing method of claim 4, further comprising the step of selecting a gradation number equal in terms of each RGB axis of the color 3D coordinate system, the gradation number being obtained from the reference color original where N-fold N² pieces of reference color images, and setting the RGB input value of the computation reference point.

7. The color image forming apparatus for forming a color image based on color image signals of a YMCK (yellow, magenta, cyan and black) signal processing system obtained by conversion from color image signals of a RGB (red, green and blue) signal processing system, the color image forming apparatus comprising:
a color conversion unit for converting inputted color image information of the RGB signal processing system into color image information of the YMCK signal processing system; and
an image forming unit for forming the color image based on the color image information of the YMCK signal processing system having undergone color conversion by the color conversion unit;
wherein the 3D color information conversion table created by the image processing apparatus of claim 1 is applied to the color conversion unit.

8. The color image forming apparatus for forming a color image based on color image signals of a YMCK (yellow, magenta, cyan and black) signal processing system obtained by conversion from color image signals of a RGB (red, green and blue) signal processing system, the color image forming apparatus comprising:
a color conversion unit for converting inputted color image information of the RGB signal processing system into color image information of the YMCK signal processing system; and
an image forming unit for forming the color image based on the color image information of the YMCK signal processing system having undergone color conversion by the color conversion unit;
wherein the 3D color information conversion table created by the image processing method of claim 4 is applied to the color conversion unit.

9. An image processing apparatus for creating a 3D color information conversion table for converting a color image signal of one signal processing system into a color image signal of the other signal processing system, based on: color measurement signals obtained by color measuring of a reference color original where N-fold N² pieces of reference color images are arranged in such a way that respective intensities of red, green and blue (RGB) of the reference color images are increased in order; and image reading signals obtained by reading the reference color originals through light exposure scanning;
the image processing apparatus comprising an extrapolation processing unit for extracting a computation reference point out of the image reading signals expressed on the color 3D coordinate system, fixing the computation reference point, connecting between the computation reference point and the computation target point, and thereby obtaining the output values of the color measurement signal corresponding to RGB input values of three apexes enclosing the RGB input value of the computation target point and to a RGB input value of the computation reference point.

10. The image processing apparatus of claim 9, further comprising an interpolation processing unit for obtaining output values of the color measurement signals corresponding to RGB input values on four apexes enclosing a RGB input value of a computation target point, when the image reading signals are expanded in a color 3D coordinate system to express the RGB input value for creating the 3D color information conversion table.
